(19) United States
(12) Patent Application Publication
(10) Pub. No.: US 2002/0147625 A1
(43) Pub. Date: Oct. 10, 2002

(54) Method and system for managing business referrals

(76) Inventor: Daniel Arthur Kolke JR., North Bend, WA (US)

Correspondence Address: SEED INTELLECTUAL PROPERTY LAW GROUP PLLC, 701 FIFTH AVE, SUITE 6300, SEATTLE, WA, 98104-7092, US

(21) Appl. No.: 09/784,870

(22) Filed: Feb. 15, 2001

(51) Int. Cl. G06F 17/60

(52) U.S. Cl. 705/9; 705/7; 705/10; 705/14

(57) ABSTRACT

The example Qualified-Referral Marketing System 100 works to establish an infrastructure to support sales professionals who desire marketing relationships with other sales professionals to exchange mutually beneficial personal introductions to qualified prospects. The example system 100 comprises a system server 101, a communication medium 102, and a plurality of clients 103 that communicate with server across the communication medium. The example system 100 comprises a Referral Partner Database Manager 104, a Referral Community Manager 105, and one or more data repositories 106. The data repositories 106 may include web pages 107, a Referral Partner Database 108, and e-mail messages 109. The Referral Partner Database Manager 104 provides services and marketing information that are used to establish referral communities. The Referral Community Manager 105 regulates the establishment of new referral communities, coordinates referrals and the operation of the referral communities, and reports on the status of various aspects of the referral communities.

### TECHNICAL FIELD

The present invention relates to a method and system for business client management and, in particular, to methods and systems for publishing and distributing business referrals.

### BACKGROUND OF THE INVENTION

Increasing competitiveness in the marketplace has required businesses to increase productivity and expand the types of services and goods they provide to the marketplace. As a result, the customers who use these products and services are faced with increased difficulties in efficiently selecting from amongst the ever-increasing variety of product offerings so that the customer will also remain competitive within the more demanding marketplace.

Traditional methods of reaching, informing, and persuading a potential customer are often not very efficient and can be unpleasant for both the customer and the sales professional alike. Telemarketing techniques such as cold-calling, while being simple to implement, have ever-decreasing success rates due to technological measures enjoyed by customers such as caller-ID, call-blocking, and the like. Other factors, such as privacy regulations and increasing distaste against intrusive sales techniques, have also restricted the ability of product and service providers to employ direct marketing.

In addition, customers are often resistant to direct marketing approaches. Customers would much rather purchase goods and services from people who they already know and trust. Likewise sales professionals prefer dealing with known customers, and highly desire receiving referrals for potential customers, especially if the referrals come from people who the customers already know and trust. Sales professionals who fail to meet their sales quotas often do not have enough quality prospects with which to work nor do they have enough time to seek potential customers using traditional methods. Sales professionals can share referrals with one another, but are often reluctant to do so because of a lack of trust and a fear that giving a referral would not benefit the person giving the referral and would instead result in lost sales, which would actually harm the person giving the referral. Therefore, it can be appreciated that there is a significant need for a method and system to enable sales professionals to receive referrals for potential customers by people known and trusted by the potential customers. It can also be appreciated that there is a significant need for a method and system to enable potential customers to receive a personal introduction to the sales professional from a person known and trusted by the potential customer. It can also be appreciated that there is a significant need for a method and system to increase the trust of people sharing referrals, and to quantify and compare the value of given referrals so that people giving referrals can determine whether sharing referrals is beneficial to the givers of referrals. The present invention provides this and other advantages as will be apparent from the following detailed descriptions and accompanying figures.

### SUMMARY OF THE INVENTION

Embodiments of the present invention provide methods and systems for facilitating the process of managing business referrals among people who desire referrals for the purpose of identifying potentially desirable clients. Embodiments include establishing a referral list that contains data related to the people who desire the referrals, storing general characterizations of potentially desirable clients by members of the people who desire referrals, sending to other members a request for referrals that indicates to the other members the general characterization of a potentially desirable client, and receiving a response to the request from at least one of the other members such that the response identifies a potentially desirable client to the requesting member.

In an exemplary embodiment, the identified potentially desirable client is sent an e-mail communication to thereby refer the identified potentially desirable client to the member seeking the referral. The identified potentially desirable client has the option of accepting the referral or declining the referral. If the potential client does not accept or decline the referral within a predetermined time period, the identified potentially desirable client is automatically reminded to do so. The list of people who desire referrals may be amended to include other individuals seeking referrals and storing characterizations of potentially desirable clients for the new member.

Exemplary embodiments also include the ability to generate sales data resulting from the referrals, and tracking referrals given by various members and reporting the referrals for the members over a predetermined period of time.

Embodiments of the present invention also provide methods and systems for facilitating using referral surveys, including sending a referral query to a customer, receiving from the customer a message containing a referral, extracting the referral from the message, and sending the referral to a subscriber. Embodiments of the present invention also contain sending a referral survey to the customer, sending to the customer an e-mail message containing a link to a referral survey, creating a referral survey in response to the customer activating the link, sending an introduction to a person named by the referral, and obtaining the subscriber's permission to send an introduction to a person named by the referral.

### BRIEF DESCRIPTION OF THE DRAWINGS

FIG. 1 is a network diagram of an example Qualified-Referral Marketing System.

FIG. 2 is an illustrated flow diagram of an example Qualified-Referral Marketing System.

FIG. 3 is a flow diagram of the setup of a referral database in an example Qualified-Referral Marketing System.

FIG. 4 is a flow diagram of the setup of a referral community in an example Qualified-Referral Marketing System.

FIG. 5 is a flow diagram of the operation of a referral community in an example Qualified-Referral Marketing System.

FIG. 6 is a flow diagram of required maintenance of a referral community in an example Qualified-Referral Marketing System.

FIG. 7 is an illustrated flow diagram of an example Referral Survey.

FIG. 7A is an illustrated flow diagram of an alternative example Referral Survey.

FIG. 8 is a block diagram of a computer system for practicing exemplary embodiments of the media classification and search system.

FIG. 9 is an illustrated flow diagram of an example Visitor Entry.

FIG. 10 is a menu of an example Referral Community Homepage.

FIG. 11 is a menu of an example Action List.

FIG. 12 is a menu of an example Manage Sales Activity menu.

FIG. 13 is a menu of an example Common Links menu.

FIG. 14 is a menu of an example Corporate Sponsored Homepage menu.

FIG. 15 is an illustrated flow diagram of an example Set Up A New Referral Community web page.

FIG. 16 is an illustrated flow diagram of an example Ideal Client Profile webpage.

FIG. 17 is an illustrated flow diagram of a Set Up a New Subscriber web page.

FIG. 18 is an illustrated flow diagram of an Invitation to Join a Referral Community web page.

FIG. 19 is an illustrated flow diagram of an example Manage my Referral Communities (Owner's Actions).

FIG. 20 is an illustrated flow diagram of an example Manage my Referral Communities (Referral Partner's Actions).

FIG. 21 is an illustrated flow diagram of an example Send a Referral web page.

FIG. 22 is an illustrated flow diagram of a Receive a Referral (Introduced) web page.

FIG. 23 is an illustrated flow diagram of the Receive a Referral (Not introduced) web page.

FIG. 24 is an illustrated flow diagram of a Set Up a Business Relationship web page.

FIG. 25 is an illustrated flow diagram of a Planning my Goals web page.

FIG. 26 is an illustrated flow diagram of an Update my Accounts web page.

### DETAILED DESCRIPTION OF THE INVENTION

Embodiments of the present invention provide computer- and network-based methods and systems for managing business referrals (a “Qualified-Referral Marketing System”). A referral is the identification of a third person passed from a first person to a second person in which the first person believes the second and third persons would be likely to establish a mutually beneficial business relationship. The art of transacting business through seeking and giving such referrals may be called “referral marketing” or “relationship marketing.” In an example embodiment, the Qualified-Referral Marketing System is a network of computers that enables sales professionals to develop referral communities. This allows sales professionals to be networked with other sales professionals who target the same or similar customers so that they may invest energy in developing referral partnerships. For reasons that will be further described below, referred partnerships have a higher probability of success in developing successful customer contacts than traditional marketing methods. Partners make introductions to their valuable clients in exchange for mutually beneficial referrals from their partners. This capability significantly increases in the efficiency for sales professionals by identifying high-quality potential sales customers, which results in higher revenues per the amount of time spent by the sales professional. Referral partners are able to grade and track the quality of the referrals they receive from other partners so that partners are able to determine if a particular referral partnership is mutually beneficial and profitable. The Qualified-Referral Marketing System also automatically tracks each referral and, for example, sends e-mail messages to educate partners as to the steps required to develop such beneficial relationships within a referral community, and to remind the partners of any outstanding actions they may need to take.

The example embodiment described herein provides applications, tools, data structures and other support to implement managing business referrals over one or more networks. One skilled in the art will recognize that many different arrangements and divisions of functionality are possible in such a Qualified-Referral Marketing System. For example, functions allocated to the HTTP server may be allocated across a plurality of such servers. Other arrangements are also possible.

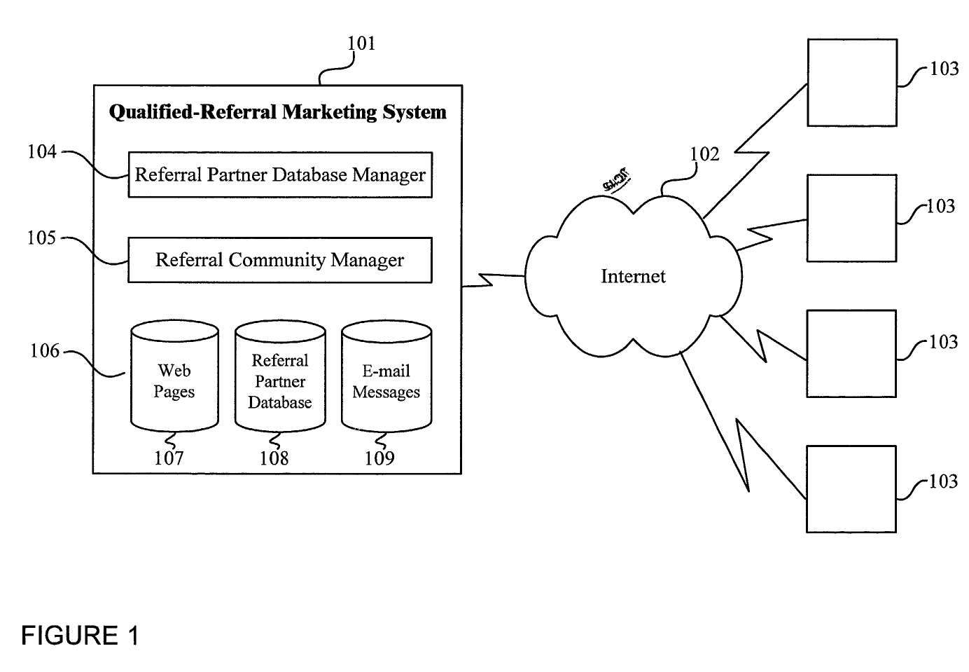

FIG. 1 is a network diagram of an example Qualified-Referral Marketing System. The example Qualified-Referral Marketing System 100 works to establish an infrastructure to support sales professionals who desire marketing relationships with other sales professionals to exchange mutually beneficial personal introductions to qualified prospects. The example system 100 comprises a system server 101, such as an HTTP server, a communication medium 102, such as the Internet, and a plurality of clients 103 that communicate with server across the communication medium. The example system 100 comprises a Referral Partner Database Manager 104, a Referral Community Manager 105, and one or more data repositories 106. For example, the data repositories 106 may include web pages 107, a Referral Partner Database 108, and e-mail messages 109. The Referral Partner Database Manager 104 provides services and marketing information that are used to establish referral communities. The Referral Community Manager 105 regulates the establishment of new referral communities, coordinates referrals and the operation of the referral communities, and reports on the status of various aspects of the referral communities. In the example of FIG. 1, many of the components are located in the server 101. However, distributed computing technologies permit these components to be located in one or more computing platforms. For example, the data repositories 106 may be located on several different computing platforms and accessible for use in the system 100. Thus, the present invention is not limited by the specified physical location of the illustrated components.

Although the example embodiment describes the invention in terms of a web browser-enabled and e-mail-enabled server and client machines communicating across the Internet, one skilled in the art will appreciate that other bi-directional communication systems operating across the communication network can be used to implement the same concepts and ideas. Even though the invention has been described in terms of having a graphical interface and pointing system such as a mouse, one skilled in the art will also appreciate that text-based browsers and menu systems may accomplish the same results.

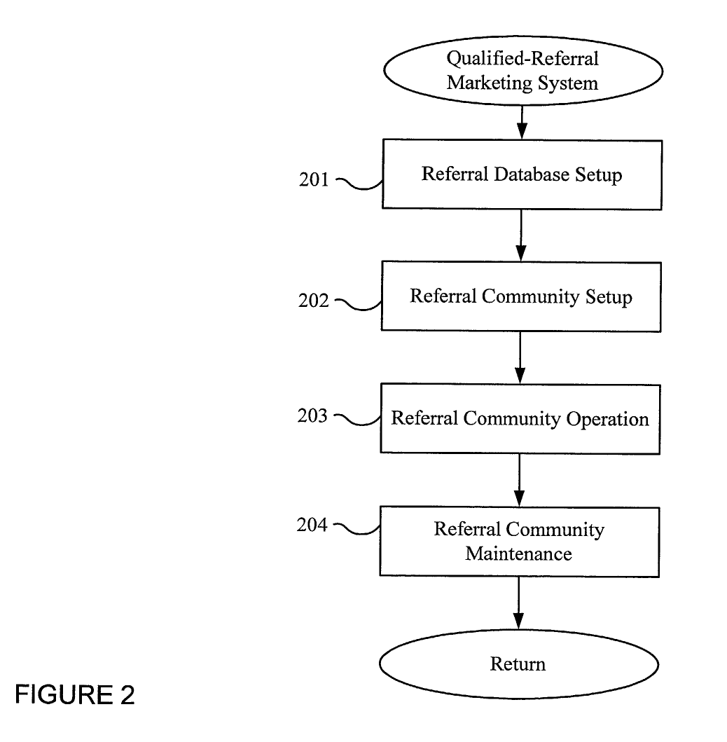

FIG. 2 is an illustrated flow diagram of an example system 100. In step 201 the referral database is set up. In this step an owner is selected for a specific referral community and information related to establishing the referral community for the owner is stored in the database. The example system 100 initially requires that a referral database be established. The referral database contains information that is used to form referral communities. A particular referral community of an example system 100 is establish initially by the inclusion of a referral community. An “owner” of a specific referral community is the individual who is responsible for selecting the types of members that will be chosen for the specific referral community and inviting the selected people to be referral partners in that community.

The information related to establishing the referral community for the owner is stored in the database. The selection of an owner to initialize a particular referral community will characterize the types of other referral partners in the referral community because the types of the other referral partners that will be added later will be complementary and will ideally share the same kinds of potential customers. For example, a referral community having a real estate professional would also have professions such as mortgage, brokerage, finance, legal, telecommunications, consulting, business services, marketing, advertising, and other professions that may be related to real estate. The selection of other referral partners to be included in the referral community may be at least partially based on the profession of the referral partner, which ensures a certain level of commonality in potential customers and thus enhances the quality and value of referrals of potential customers. As those skilled in the art can appreciate, other referral communities will have a different set of professions that are complementary and related to the needs of the community. For example, a referral community to handle the needs of a small business may include management consultants, office supply sales representatives, and the like.

In step 202 the referral community is set up wherein referral partners are added to the referral community. In step 203, partners within a referral community assess the needs of other partners and recommends referrals based upon the needs of the other partners. Finally, in step 204, actions that are necessary to maintain the quality and expectations of partners in the referral community are taken.

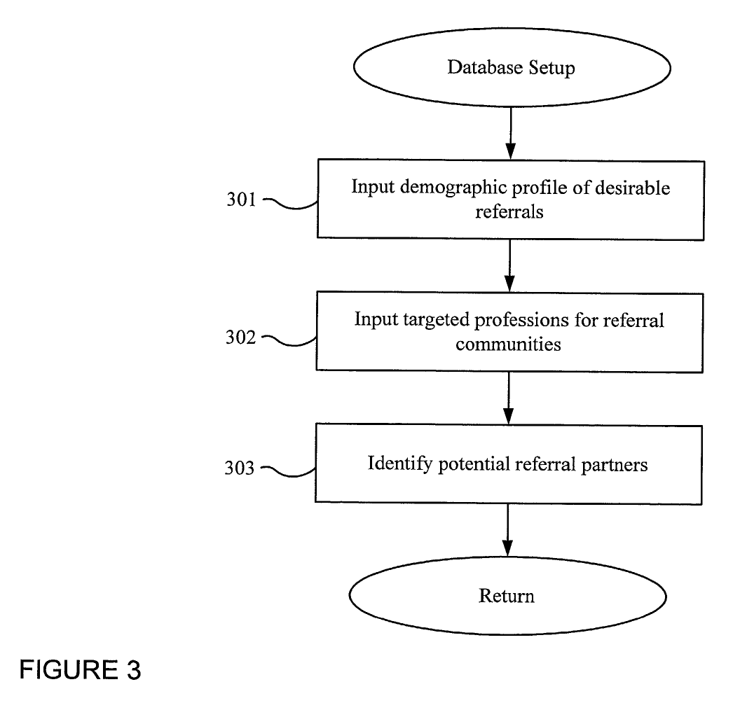

Step 201 in FIG. 2 describes the setup of a referral database. FIG. 3 is a flow diagram that provides additional details of the setup of the referral database 108 (see FIG. 1) in an example system 100. In step 301, the kinds of potential customers of the particular initial referral partner are entered into the referral database 108 by listing a demographic profile of desirable referrals. The demographic profile contains various categories useful for describing the kinds of potential customers that are desirable referrals for the initial partner. The categories contain classifications such as the kind of potential customer (i.e., individual or corporate), gender, marital status, number of children, status of homeownership, age range, and income range. When additional partners are added to the referral community, demographic profiles of desirable referrals for the additional partners are added to the referral database 108. The process of adding partners to a particular referral community is described in greater detail below.

In step 302, targeted professions of potential referral partners are entered into the referral database 108. The setup of the referral database 108 in an example system 100 entails targeting a group of candidate companies and their sales representatives who would potentially be willing to participate in the referral community. The candidate companies will ideally have complementary business relationships with the particular initial referral partner. That is, the candidate companies will not to be in direct competition with the particular initial referral partner, although they would ideally share the same kinds of potential customers. Examples of such targeted professions include real estate, mortgage, brokerage, finance, legal, telecommunications, consulting, business services, marketing, advertising, and the like.

In step 303, potential referral partners are identified and interviewed. The candidate companies of step 302 are surveyed to collect information about the willingness of the sales personnel of the candidate companies to share business referrals with other partners in the referral community. Information concerning the types of business, types of customers, and willingness of the sales professionals to share in a referral community is stored in the referral database 108 (see FIG. 1). Suitable matches for members of a referral community are identified through processing information in the referral database 108 using search techniques such as fuzzy logic, heuristics, and other matching algorithms well-known in the art. The results of processing the information in the referral database 108 is then used to select appropriate companies from which suitable referral partners may be found.

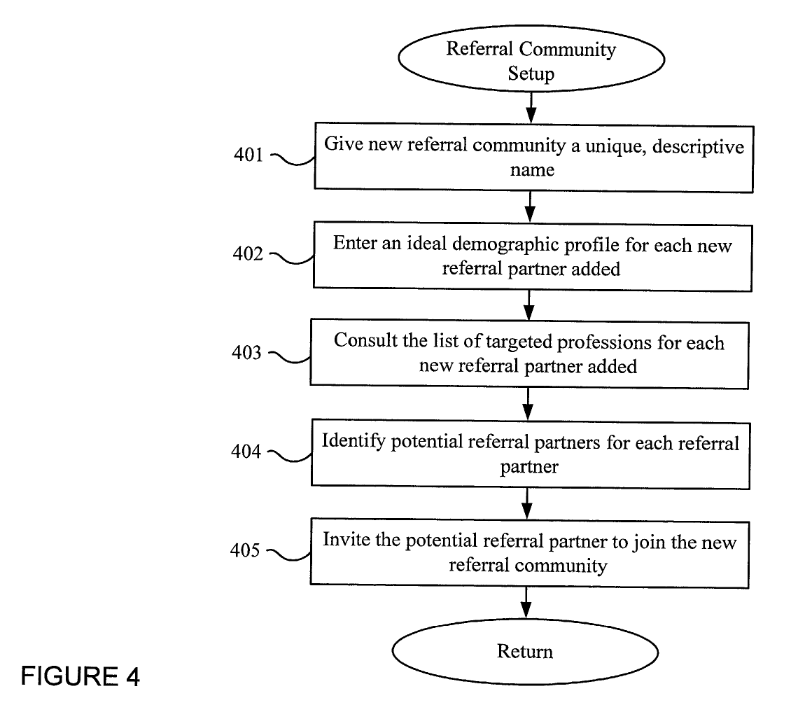

Step 202 of FIG. 2 describes the setup of the referral community after the referral database has been initialized and used to identify potential referral partners. FIG. 4 is a flow diagram that provides additional details of the setup of a referral community in an example system 100. In step 401 a particular referral community is given a name that uniquely identifies the particular referral community. The name should also be descriptive of the particular referral community so as to attract additional referral partners. Online help tools may be used to facilitate the naming of the particular referral community.

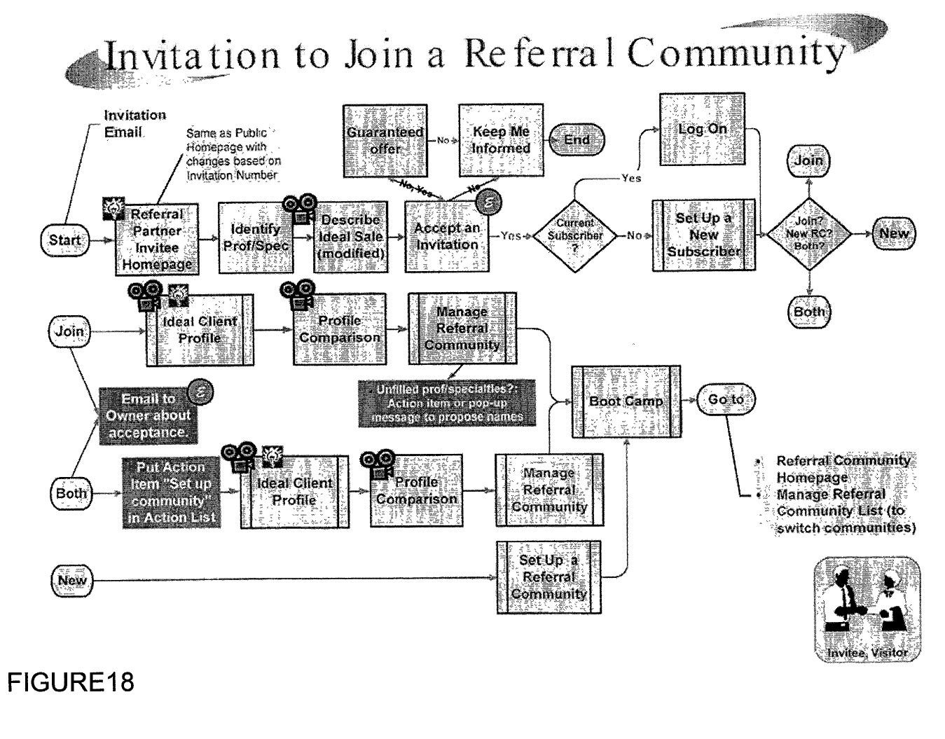

In step 402, an ideal demographic profile of desired referrals is entered for every new referral partner added to the particular referral community. In step 403, the list of targeted professions in the referral database is consulted for every new referral partner added to the particular referral community to ensure that the professions represented in the particular referral community are complementary rather than competitive. In step 404, potential referral partners are identified based upon the professions of the potential referral partners and the kinds of represented targeted professions in the particular referral community. In step 405, the potential referral partners are invited to join the particular referral community (which is described below with respect to FIG. 18).

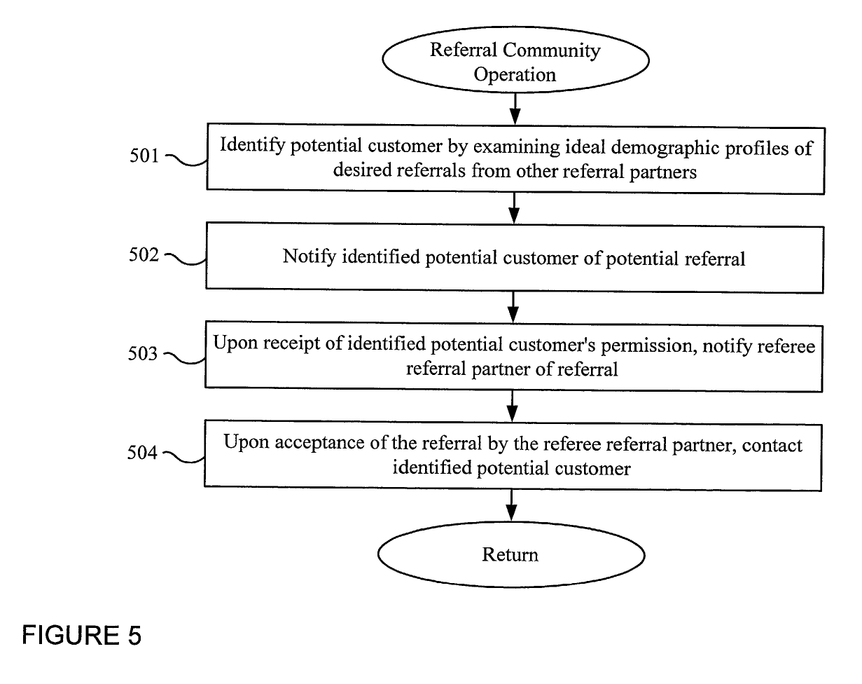

Step 203 of FIG. 2 describes the operation of the referral community after the referral community has been set up and populated with qualified referral partners. FIG. 5 is a flow diagram that provides additional details of the operation of a referral community in an example system 100. In step 501 the referral partners of a particular referral community examine the ideal demographic profile of desired referrals that other referral partners have submitted to the example system 100.

In step 502 a communication such as an e-mail message is sent to the potential customer by a particular referral partner who notices a profile match between the potential customer and another partner in the referral community. A particular referral partner (a “referring partner”) uses the referral database 108 (see FIG. 1) to determine that the ideal demographic profile of desired referrals of a selected referral partner (a “receiving partner”) matches a potential customer (the “contact”) of whom the particular referring partner is aware. When a match is detected, the referring partner uses a convenient menu item of the example system 100 to send a communication, such as an e-mail message to the contact that notifies the contact of the profile match and that asks the contact for permission to introduce the contact to the receiving partner. One skilled in the art will appreciate that other forms of communication may be used to send the message, such as paging services (including digital wireless), automatically generated phone messages (including cellular and mobile phones), postal letters, and the like.

In step 503 a communication is sent on behalf of the contact to the referring partner that grants permission for the referring partner to notify the receiving partner of the existence of the contact and to convey profile information about the contact. If the contact does not send a communication in response to the match notification, the system 100 may automatically send a communication, such as an e-mail, to remind the contact of the possible referral and to encourage a favorable response. If the contact declines the possible referral, then information regarding the contact is not passed along to the selected receiving partner. This permission-based transferal of personal information avoids many potential privacy concerns. In an alternative example of the system 100, the referring partner may bypass seeking permission from the contact, and directly contact the receiving partner with the identity of the potential customer.

In step 504 the receiving partner, who has been notified of the contact, sends the referring partner a confirmation message that either accepts or declines the referral from the referring partner. If the receiving partner accepts the referral, an introductory message is sent to the contact, which provides a direct introduction of the receiving partner and the basis upon which the receiving partner may place a follow-up phone call. If the receiving partner declines the referral, an introductory message need not be sent to the potential customer. In one embodiment, the introductory message, such as an e-mail, may be automatically generated by the system 100. The receiving partner may send the message or edit it to provide greater personalization in the introduction process.

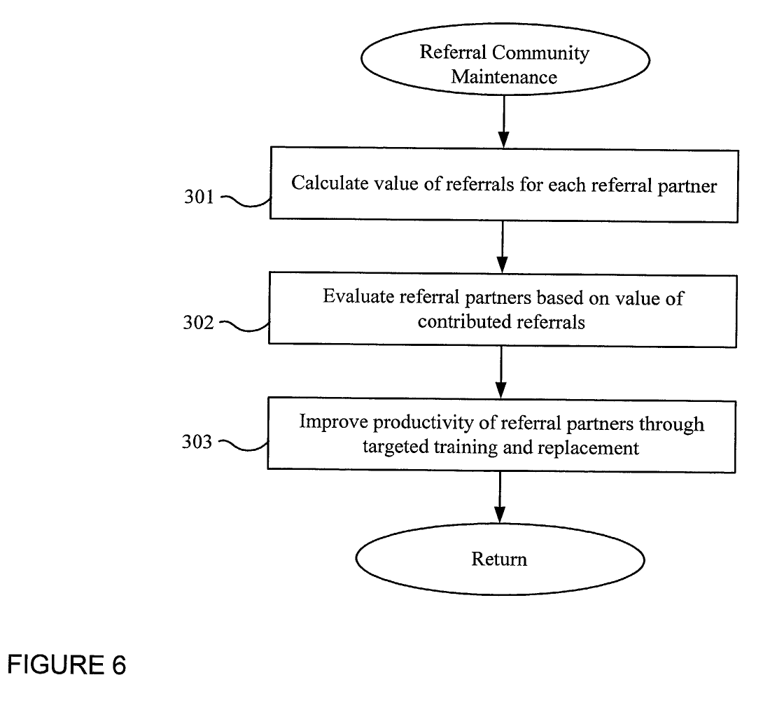

Step 204 of FIG. 2 describes actions are taken that are necessary to maintain the quality and expectations of partners in the referral community. FIG. 6 is a flow diagram that provides additional details of required maintenance of a referral community in an example system 100. In step 601, the value of the referrals is calculated and presented. In one example embodiment, each receiving partner submits the value of the revenue received as a result of each referral that the receiving partner has received through the referral community. In this example embodiment, the system 100 calculates the totals of the value of the referrals received by each receiving partner, and also calculates the value of the referrals that have been given by each referring partner. The example system 100 uses these values to rank the productivity of each partner in a particular referral community member, to identify partners for whom further training is needed, and to identify consistently unproductive referral partners who may need to be replaced as discussed below with reference to step 603. In another example embodiment, the receiving partners may submit the number and average value of the referrals. Other objective measures of the economic value of referrals may also be used in the system 100.

The example system 100 uses the submitted values of the referrals to calculate the value of the referral community to each partners. The example system 100 continually tracks the parameters necessary for this calculation. The average value per community is calculated using the dollar value of an ideal sale, the average closing percentage from a personal introduction, the number of partners in the referral community, and the average number of referrals per month per partner. From these factors various indicators can be calculated including the average number of referrals per month, the average number of sales closed per month, the average dollar value of each referral, the total monthly revenue from referrals, and the average value per referral partner. One skilled in the art will readily appreciate that algebraic manipulation will allow various factors to be calculated rather than entered, and other factors to be entered rather than calculated.

Table 1 demonstrates an example of the factors mentioned above using a dollar value of an ideal sale of $2500, and average closing percentage from a personal introduction of 75%, in number of referral partners of 8 partners, and an average number of referrals per month per partner of being 0.5 referrals per month, the average number of referrals per month can be calculated by multiplying the number of referral partners by the average number of referrals per month per partner, which in this case results in an average of four referrals per month.

TABLE 1
Average Value Per Community

| | |
|---|---|
| $2,500 | Dollar Value of an Ideal Sale |
| 75% | Average Closing Percentage From a Personal Introduction |
| 8 | Number of Referral Partners |
| 0.5 | Average Number of Referrals Per Month Per Partner |
| 4 | Average Number of Referrals Per Month |
| 3 | Average Number of Sales Closed Per Month |
| $1,875 | Average Dollar Value of Each Referral |
| $7,500 | Total Monthly Revenue from Referrals |
| $938 | Average Value Per Referral Partner |
| $90,000.00 | Annual Revenue From Community |
| $11,250.00 | Average Value Per Referral Partner |

In Table 1, the average number of sales closed per month can be calculated by multiplying the average number of referrals per month by the average closing percentage from a personal introduction, which in this case results in an average number of three sales closed per month. Using the same example figures, the average dollar value of each referral can be calculated by multiplying the dollar value of an ideal sale by the average closing percentage from a personal introduction, which results in an amount of $1875. The total monthly revenue from referrals can be calculated by multiplying the dollar value of an ideal sale by the average number of sales closed per month, which when using the same example figures results in amount of $7500. The average value per referral partner can be calculated by dividing the total monthly revenue from referrals by the number of referral partners, which results in an amount of $938 average value per referral partner per month based on using the example figures. For use in budget projections monthly values are be annualized by multiplying by 12 for budgeting purposes.

The example system 100 also accepts, calculates, and presents information from multiple referral communities, to which individual referral partners may belong or in which a single entity may be represented by a plurality of referral partners. For example, a corporation that is represented by several referral partners in differing referral communities can have sales figures from the representing referral partners in the differing referral communities presented in aggregate form.

In step 602, the example system 100 uses the calculated values of the referrals to evaluate the benefits and contributions of each partner to assess the level of cooperation amongst the partners in a referral community. Partners in a particular referral community are ranked, inter alia, by the value of the referrals provided to other partners in the referral community, and by how much revenue they have generated as a result of referrals they have received from other partners in the referral community. The ranking can be used to reward those partners who have contributed highly as well as to provide targeted training and encouragement to less productive partners in the referral community.

In step 603, the example system 100 uses the rankings to generate particular e-mail messages in response to the generated rankings. For example, the partner who has generated the most revenue through referrals to other referral partners can be acknowledged by an e-mail message that is automatically generated by the example system 100 and sent to all partners in a referral community. In another example, a partner who obtained a low ranking in the number of referrals per month submitted, can be sent an automatically generated e-mail containing encouragement and tips and suggestions for improvement. If the rankings do not materially improve over time, the non-improving partner may optionally be flagged for possible replacement by the owner of the referral community.

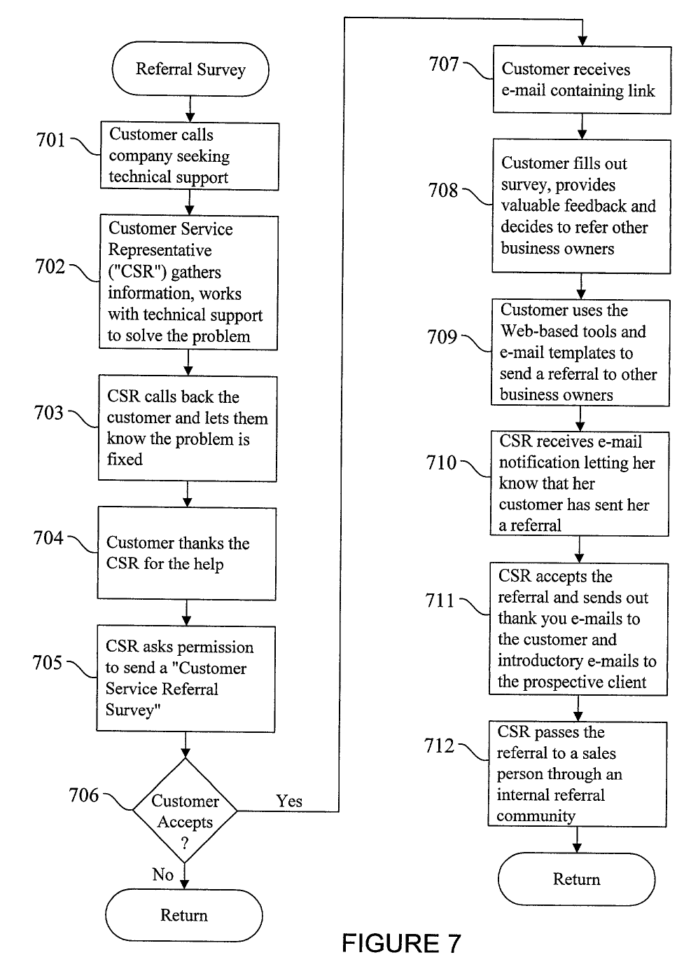

In alternate embodiments, referral partners can expand the pool of potential referrals by using the referral system to manage referrals from customers and clients of the referral partners. FIG. 7 is a flow diagram of an alternative example system 100 used by a customer service department to generate referrals from customer contacts. In step 701, a customer calls the company's customer service department seeking, by way of example, technical support. In step 702, the customer service representative (a “CSR”) gathers information (including current contact information such as phone number, e-mail addresses, mailing address, and the like) from the customer and works with the company's technical support department to solve the problem about which the customer called. In step 703, the CSR notifies the customer of the resolution of the problem. In step 704, the customer (typically) thanks the CSR for the help thus indicating that the phone call is ending. In step 705, before terminating the phone call, the CSR asks the customer for permission to send the customer a “Customer Service Referral Survey.”

One skilled in the art will readily appreciate that more aggressive companies may choose to forego asking the customer for permission and may simply send the Customer Service Referral Survey to the customer. In step 706, if the customer accepts the proposal to be sent the “Customer Service Referral Survey” the procedure continues in step 707 and, if not, returns. In step 707, the customer receives an e-mail generated by the system 100. The e-mail message may contain a hyperlink, which enables the customer to easily visits the web site that contains a Customer Service Referral Survey. Alternatively, the customer may simply reply to the e-mail message directly. In step 708, the customer activates the hyperlink contained within the received e-mail and visits the web site containing the Customer Service Referral Survey. The customer enters text into the interactive web page to answer the survey questions, which solicits valuable feedback from the customer as well as referrals for other customers.

In step 709, the customer uses web-based tools and e-mail templates provided by the web site containing the “Customer Service Referral Survey” to send referrals to other potential customers. In step 710, the CSR receives an e-mail message generated by the customer service web site that notifies the CSR that the customer has submitted a referral. In step 711, the CSR accepts the referral and sends a “thank you” e-mail message to the customer and also sends introductory e-mails to the potential customers. In step 712, the CSR relays the referral to a company sales representative through an internal referral community that comprises company sales representatives as referral partners. Thus, the system 100 is applicable to corporate settings as well as independent business entities. Economic analysis may be performed in the corporate implementation in the manner described above. One skilled in the art will appreciate that the referral survey routine may be used to seek referrals in situations where the requests for customer service is submitted and handled by using e-mail as well.

FIG. 7A is a flow diagram of an alternative example system 100 used by a subscriber of a Qualified-Referral Marketing System using the system to generate additional referrals from their customers. In step 751, a subscriber sends an e-mail message containing a link pointing to the Qualified-Referral Marketing System to the customer. The subscriber may send the e-mail directly to the customer or supply the customer's contact information to the Qualified-Referral Marketing System for the system to automatically generate the e-mail to the customer. The e-mail message will typically thank the customer for their business and suggest that the customer follow the link contained in the e-mail to answer a survey concerning the performance of the subscriber in past business dealings with the customer.

In step 752, the customer accesses the link to retrieve a survey that is generated by the Qualified-Referral Marketing System. One skilled in the art will appreciate that the survey alternatively may be sent directly to the customer by the subscriber, in which case the subscriber would notify the Qualified-Referral Marketing System of the fact that the customer had been sent a survey directly by the subscriber. In step 753, the customer answers the questions on the survey and submits the completed survey. The survey, for example, may contain questions that ask the customer to rate the quality of the services provided by the subscriber to the customer by selecting a value from the range of numbers for each question that asks the customer for his or her opinion of the services provided by the subscriber. One skilled in the art will appreciate that the survey may be returned by the customer directly to the Qualified-Referral Marketing System or be returned to the subscriber, who would then notify the Qualified-Referral Marketing System that the survey has been returned.

In step 754, the system sends a referral query to the customer asking the customer to provide names of potential clients that customer thinks would like to do business with the subscriber. One skilled in the art will recognize that the referral query may be generated and sent by the system (e.g., by email) or by the subscriber, who notifies the system that the referral query has been sent to the customer. In step 755, if the customer responds to the referral query by submitting one or more names of potential clients, the routine proceeds to step 756, or the process ends if the customer does not respond. In step 756, the system receives the referral and extracts the contact information of the potential client from the received referral. One skilled in the art will appreciate that information may be extracted from electronic messages by a variety of means, including parsing using regular expressions. In step 757, the system sends an e-mail message to the subscriber containing the names of any referrals that have been provided by the customer. In step 758, if the subscriber wants to be introduced to the referred potential client, the process proceeds to step 759, or else proceeds to step 760 if the subscriber does not desire an introduction. In step 759, the system after obtaining approval from the subscriber sends an e-mail message to the referred potential client that contains an introduction to the subscriber. In step 760, the system sends a “thank-you” e-mail message to the customer thanking the customer for the referral.

Many features of the example referral survey routines have not been mentioned for the purpose of not obscuring the invention. For example, the system automatically monitors the status and progress of every step in the routine, and provides the current status to the subscriber upon request and send reminder messages to people who may have not responded after a reasonable time period set by the administrators of the system. The system also compensates for many of the problems encountered in establishing business relationships and passing referrals by providing template e-mail messages in a timely fashion that people may modify to best suit their own purposes. The referral survey also helps to improve the quality of the business relationships of a subscriber with the subscriber's customers by providing useful feedback of the subscriber's performance by which the subscriber may improve.

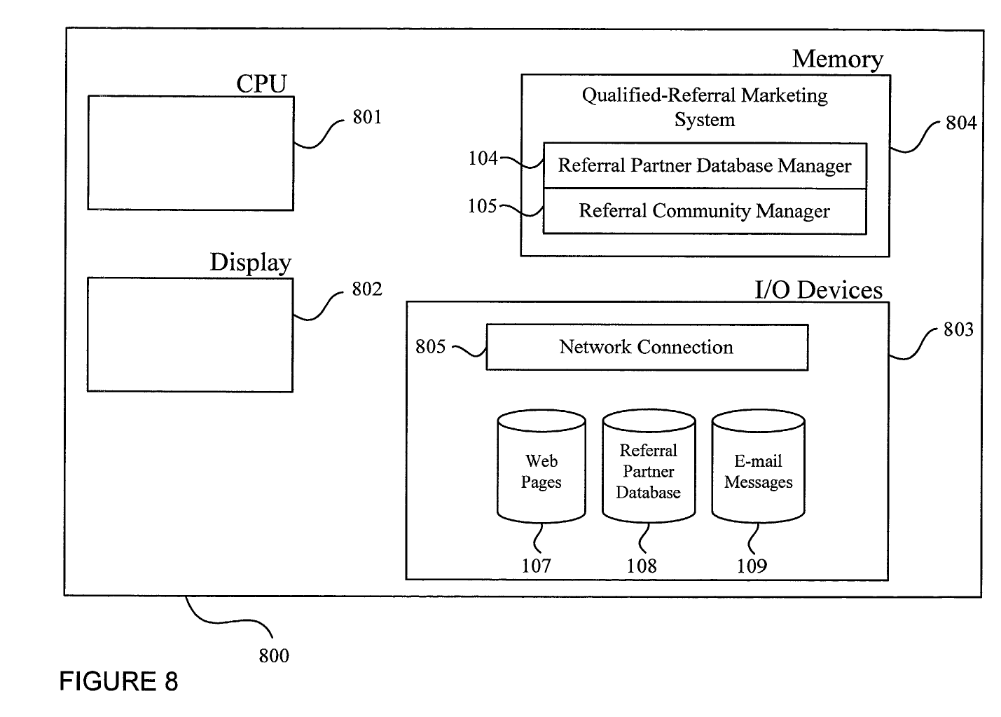

FIG. 8 is a functional block diagram of a computer system for practicing exemplary embodiments of the media classification and search system. A computer system 800 contains a central processing unit (CPU) 801, a display screen (display) 802, input/output devices 803, and a computer memory (memory) 804. The routines for implementing the Referral Partner Database Manager 104 and the Referral Community Manager 105, as well as the operating system code for hosting the system 100 routines, reside in the memory 804 and execute on at least one CPU, such as the CPU 801. The CPU 801 may be implemented by any conventional processing device, such as a microprocessor, programmable controller, programmable logic array (PLA), digital signal processor (DSP), or the like. The present invention is not limited by the specific device selected to implement the function of the CPU 801. The operating system code also controls the initialization and maintenance of the various network connections. The input/output devices 803 are shown containing a network connection 805 and one or more storage devices for the data repositories containing the web pages 107, the Referral Partner Database 108, and the e-mail messages 109. One skilled in the art will recognize that the data repositories of the system 100 may reside on or across multiple, or even heterogeneous storage devices.

The network connection 805 demonstrates that example embodiments operate in an environment where the computer system is connected to one or more networks, remote or local. One skilled in the art will recognize that the methods and systems of the present invention may be practiced on processing systems with varying architectures, including multi-processor environments, or on systems with hard wired logic. Also, one skilled in the art will realize that the present invention can be implemented in a stand-alone environment having no network access.

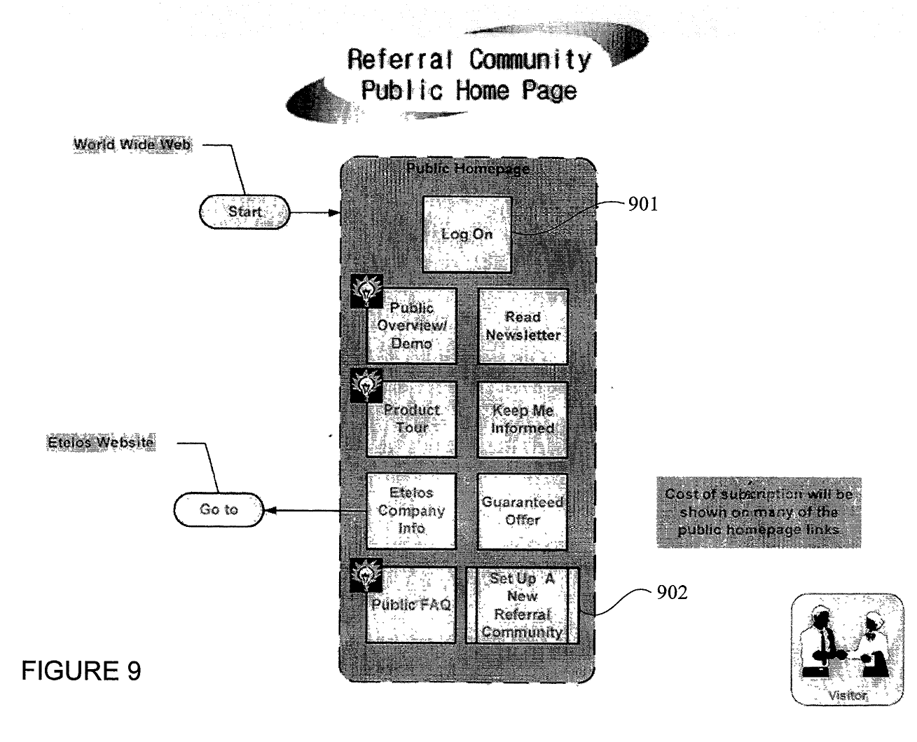

FIG. 9 is a menu of an example Referral Community Public Homepage. One skilled in the art will appreciate that a menu may be presented as a web page, or even a series of web pages. The menu permits visitors to enter certain pages of the system 100 web site (“web site”) by selecting from amongst the various presented menu items. The selection of menu items occurs using conventional techniques that need not be described in detail herein. For example, a cursor may be positioned over a desired menu item by manipulation of a mouse (not shown) and the desired menu item activated by clicking a mouse button. Subscribers may logon using a Logon 901 item. A visitor, who has not yet subscribed, may select an item 902 to set up a new referral community on a trial basis. Individuals that have already subscribed to the service, may set up a new referral community by selecting the item 902. Other items are used to provide links to other sites, and provide training and motivational information.

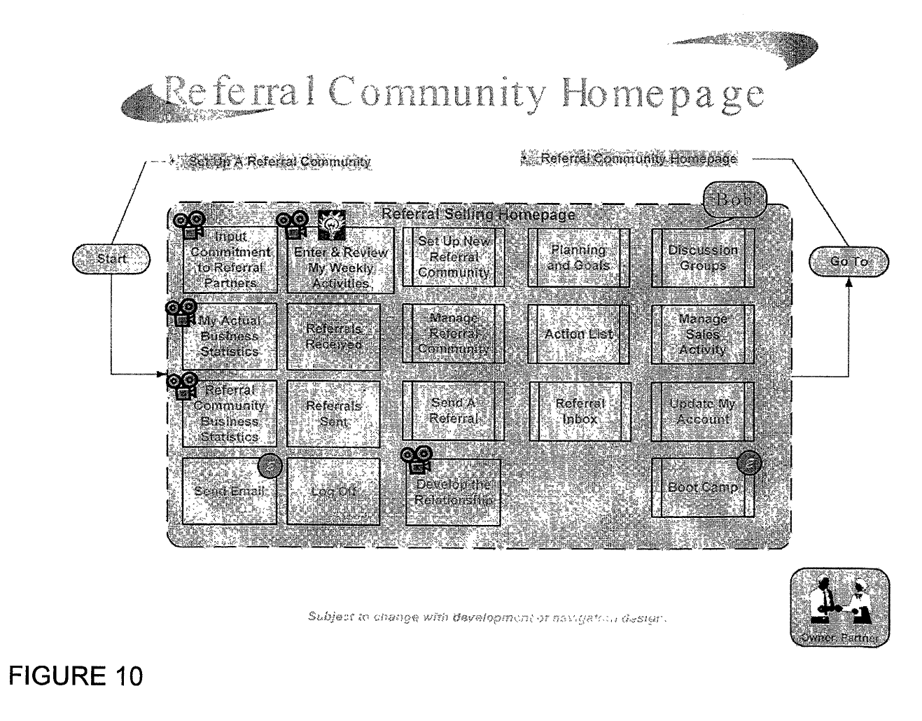

FIG. 10 is a menu of an example Referral Community Homepage. After selecting the logon item 901 and logging on via the Referral Community Public Homepage, subscribers and owners of referral communities may select from amongst the presented menu items to review status, send and receive referrals, manage referral communities, communicate with other referral partners via e-mail and discussion groups, as well as receive motivational in training materials, as well as to log off. Several of the items illustrated in FIG. 10 are discussed in greater detail to provide a more complete understanding of the system 100.

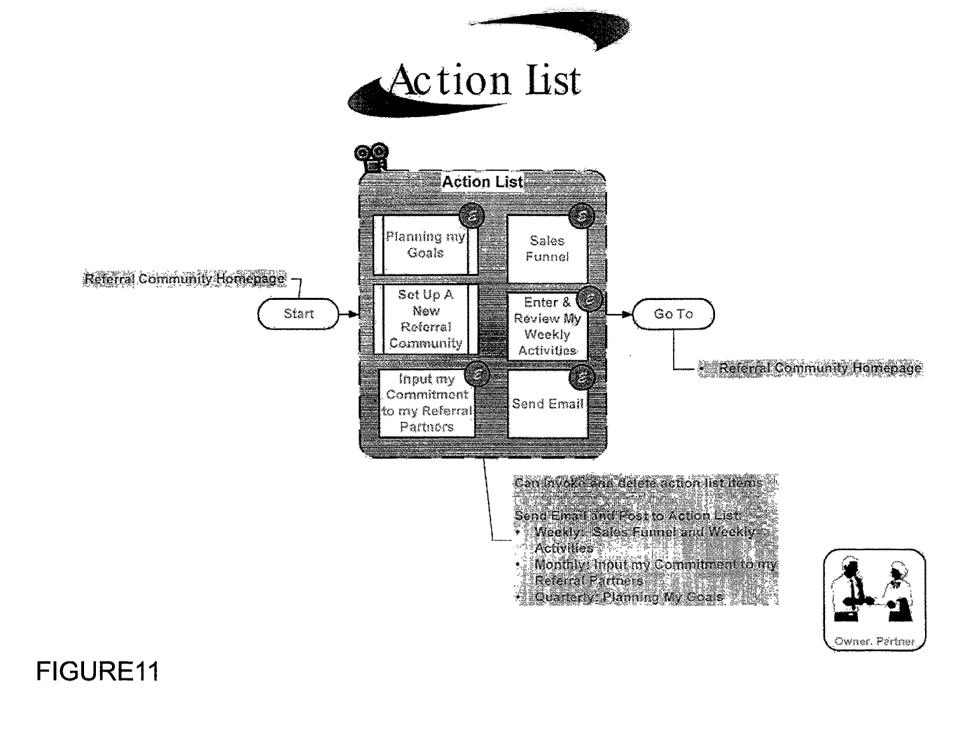

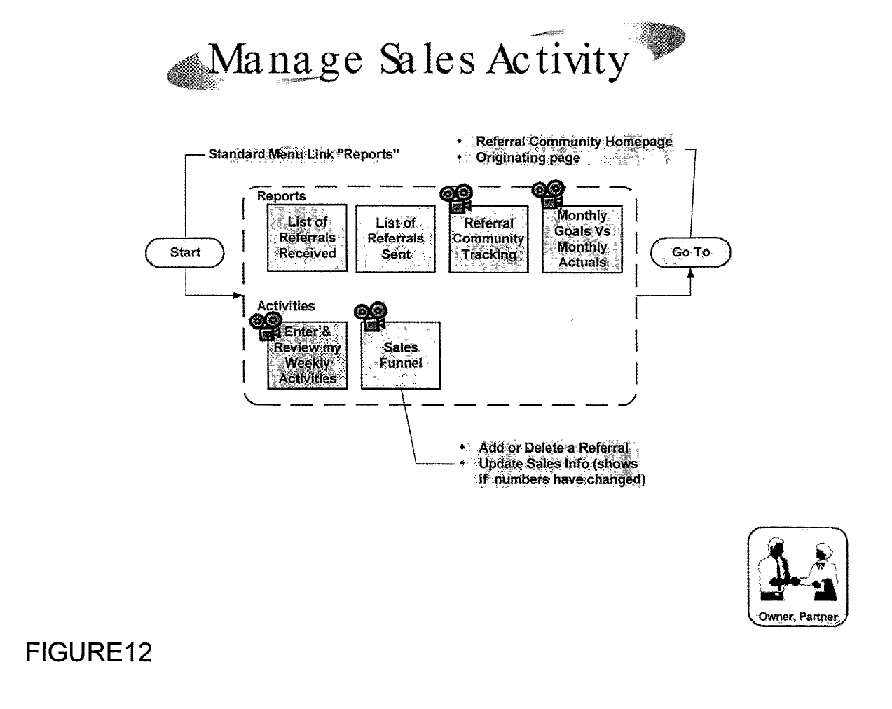

FIG. 11 is a menu of an example Action List displayed in response to the selection of the Action List item of FIG. 10. Subscribers and owners of referral communities may enter the Action List menu by selecting that item from the Referral Community Homepage. The Action List is a customizable menu that contains menu items that a referral partner may include to provide a visual indication of the priority of certain tasks as well as to provide a convenient reference to the menu items. Furthermore, the referral community manager 105 may automatically insert menu items into the Action List that are scheduled to be performed. For example, on a weekly e-mail reminder and a menu item for “Sales Funnel and Weekly Activities” (described below with reference to FIG. 12) may be posted to the referral partner's Action List. A monthly e-mail reminder and a menu item for the “Input my Commitment to my Referral Partners” may also be added to the Action List. On a quarterly basis, an e-mail reminder and a menu item for “Planning Money Goals” is added to the Action List. Those skilled in the art will recognize that other time periods (e.g., bimonthly) may be used by the system 100 to automatically generate e-mail messages. Alternatively, the system 100 may automatically generate the e-mail messages if a partner in a referral community has no performed some action within a predetermined time period. For example, the system 100 can automatically generate a reminder e-mail if a partner has not performed some action, such as, by way of example, reported “Sales Funnel and Weekly Activities” for more than one week.

FIG. 12 is a menu of an example Manage Sales Activity menu. Subscribers and owners of referral communities may enter the Manage Sales Activity menu by selecting that item from the Referral Community Homepage (see FIG. 10) or optionally through the Action List menu (see FIG. 11). The Manage Sales Activity menu of FIG. 12 allows a referral partner to access various reports including a list of referrals received, a list of referrals sent, statistics for tracking the performance of the referral community, and a comparison of targeted performance versus actual performance for a given time period. The Manage Sales Activity menu also allows a referral partner to enter and review the weekly activities of other partners in the referral community and manage the “Sales Funnel,” which allows the partner to add or delete referrals and to update sales information.

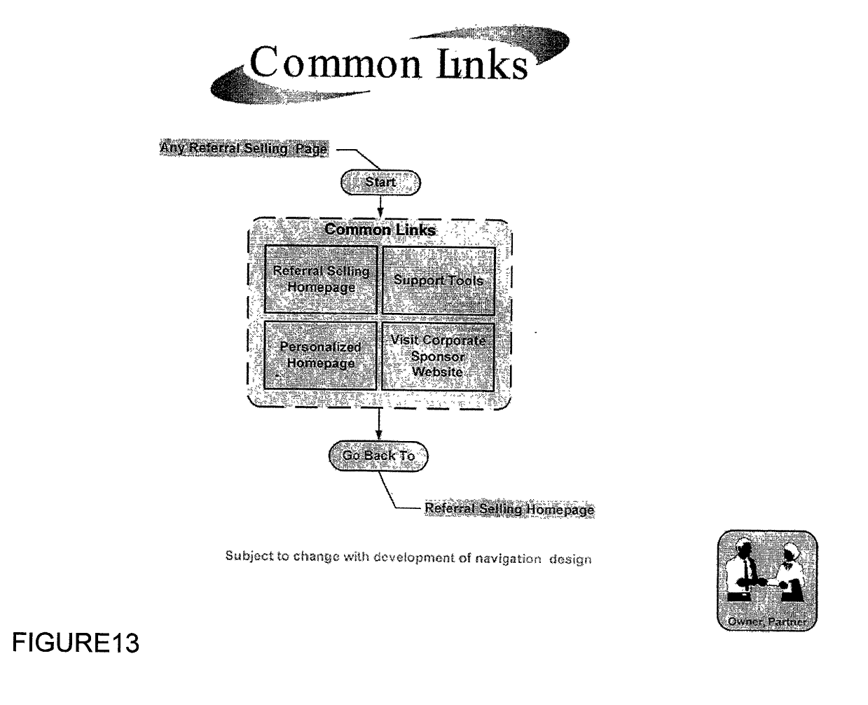

FIG. 13 is a menu of an example Common Links menu. The Common Links menu functions as a link page, which may include links to the Referral Selling Homepage, support tools, a personalized homepage of the referral partner, Corporate Sponsored web sites, and the like. The Common Links menu may be accessed from the variety of web pages to which the subscriber and owner of a referral community have access. It will be apparent to one skilled in the art that web pages in a web site can be linked together using any organizational scheme, or even using no coherent organizational scheme. The structure of the web site of an example system 100 described herein is for purposes of illustration, and does not exclude other organizational structures. For example, a site map may contain links to every web page within the example system 100.

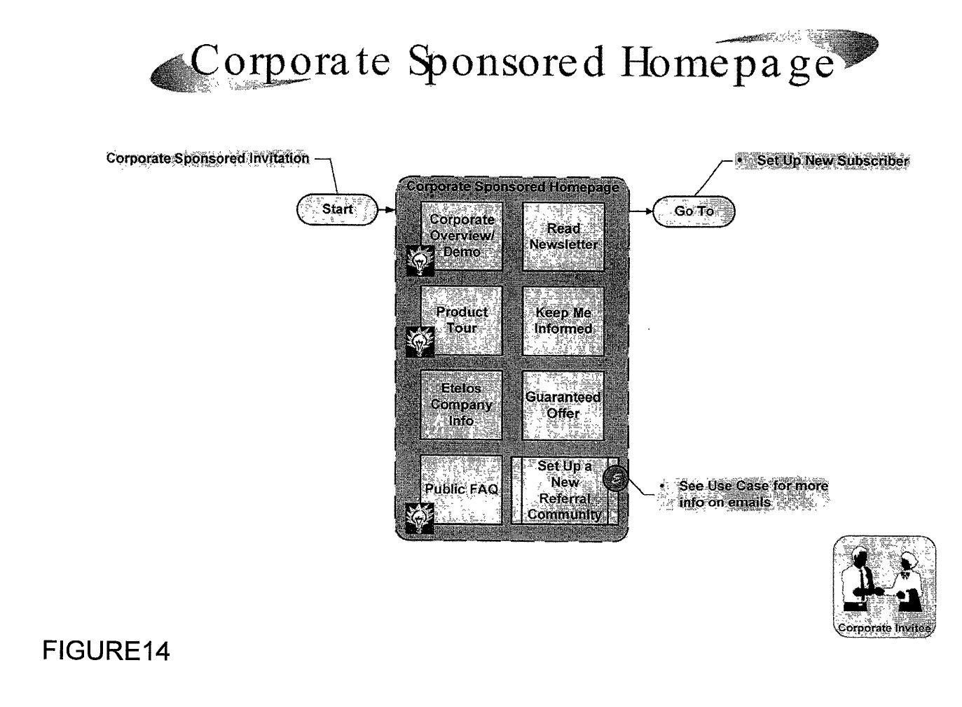

FIG. 14 is a menu of an example Corporate Sponsored Homepage menu. Subscribers and owners of referral communities may access the Corporate Sponsored Homepage by selecting the menu item in the Common Links menu (see FIG. 13). The Corporate Sponsored Homepage of FIG. 14 provides information about the Corporation, Frequently Asked Questions (FAQs), Newsletters, sales offers, and provides a menu item to set up a new referral community that would be related to the particular Corporation. Operational details of the system 100 to set up a referral community are provided below.

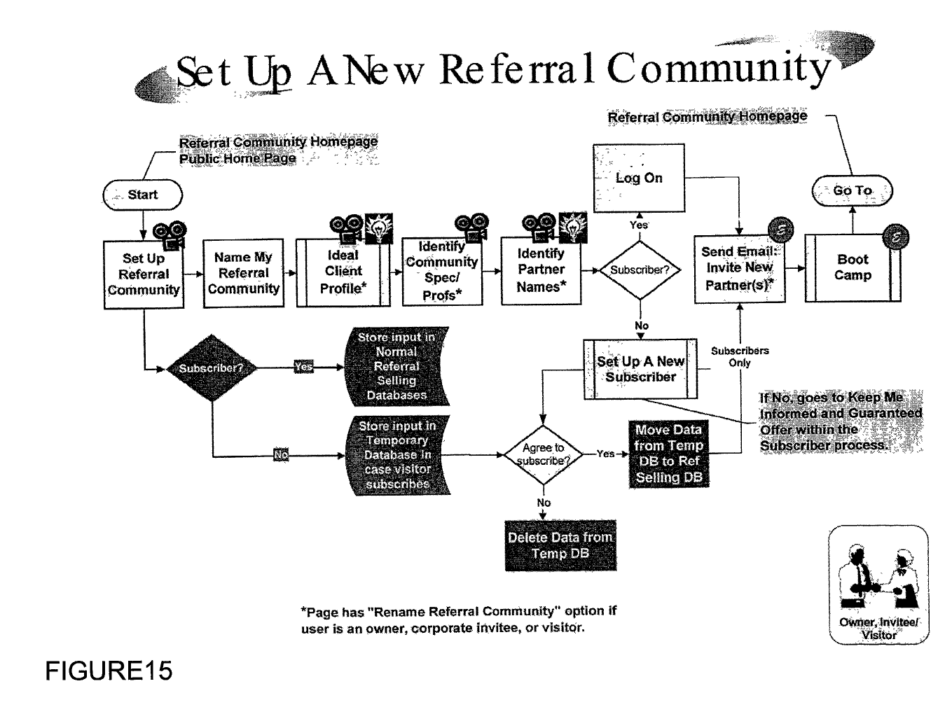

FIG. 15 is an illustrated flow diagram of an example Set Up a New Referral Community web page. One skilled in the art will appreciate that the information presented and functions performed by a web page may be presented and performed by using multiple web pages, multiple frames, multiple windows or “pop-ups,” and the like. Visitors, subscribers, and owners may access the Set Up a New Referral Community web page from the Referral Community Public Homepage (see FIG. 9), the Referral Community Homepage (see FIG. 10), or the Corporate Sponsored Homepage (see FIG. 14). In the example Set Up a New Referral Community web page of FIG. 15, referral community owners, subscribers, or visitors may establish new referral communities. If the person setting up the new referral community is a subscriber (which includes owners), data for the new referral community will be stored in the normal referral database (e.g., the referral partner database 108 of FIGS. 1 and 8), or else the data will be stored in temporary databases (not shown) for visitors. The person setting up the new referral community will provide a name for the referral community, provide an ideal client profile (discussed below with reference to FIG. 15), identify the types of professions to be represented in the referral community, and identify candidates for referral partners according to the professions to be represented within the new referral community. Once the new referral community has been established, subscribers may logon and use the system 100 to send e-mail messages to invite the candidates to join the new referral community. The system 100 logs the invitation for new candidates and assigns the invitation a serial number that is used to track the invitation as well as to identify the parties associated with the invitation. The system 100 will send training materials to participating partners to guide them in the proper use of the system. Visitors will be given the opportunity to subscribe within certain time periods and at various points within the process. It will be apparent to one skilled in the art that visitors may be given temporary subscriber privileges for a trial period. When a visitor agrees to subscribe, the visitor's data stored in temporary databases is moved to the normal referral databases; if the visitor does not agree to subscribe, the associated data may be deleted from the temporary database.

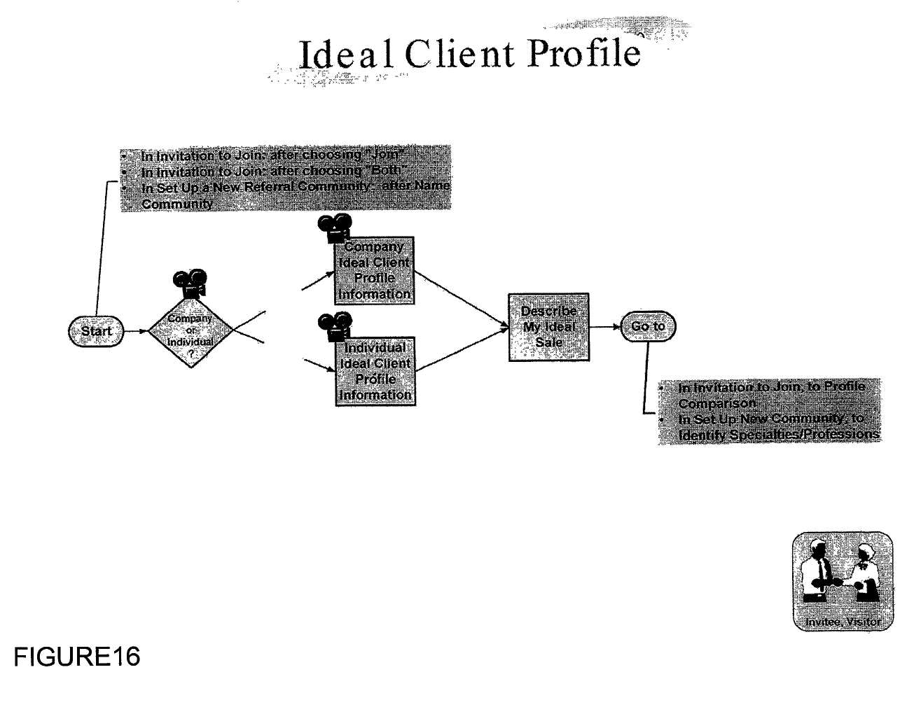

FIG. 16 is an illustrated flow diagram of an example Ideal Client Profile web page. Invitees and visitors may access the Ideal Client Profile web page from the Invitation to Join web page (which is discussed below with reference to FIG. 18) or from the Set Up a New Referral Community web page (see FIG. 15). The ideal client profile web page may be used by invitees and visitors to describe characteristics of their clients that are useful for marketing purposes. Client characteristics for individual clients may include, by way of example, gender, marital status, number of children, status of homeownership, age range, income range, and the like. The Ideal Client Profile may be used to describe attributes relating to an individual or a corporate entity. Characteristics for an ideal corporate client may include, by way of example, corporate size, market capitalization, privately held or publicly traded, profit margins, and the like. The invitee or visitor may also described their ideal sale with respect to the ideal client.

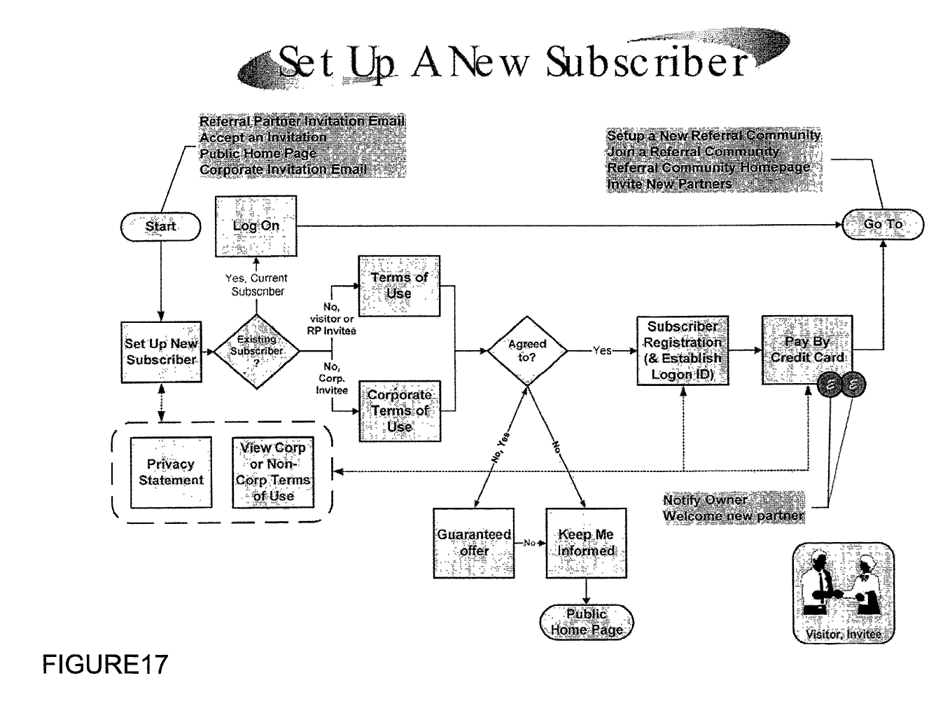

FIG. 17 is an illustrated flow diagram of a Set Up a New Subscriber web page. Invitees and visitors may access the Set Up a New Subscriber web page from the link contained within the Referral Partner Invitation E-mail, from an Accept an Invitation link or web page, from the Referral Community Public Home Page (see FIG. 9), or from a Corporate Invitation E-mail. The Set Up a New Subscriber web page of FIG. 17 allows visitors, referral partner invitees, and corporate invitees to become new subscribers. These entities are presented a privacy statement and the terms of a license under which an entity may subscribe. If the potential new subscriber does not agree to the terms, additional terms may be optionally presented so as to urge the potential subscriber to subscribe. If the potential subscriber still does not agree to the terms presented, then the web page will log contact information of the reluctance potential subscriber so that promotional materials might be sent to the potential subscriber. The potential subscriber who accepts the terms of the presented license will register by establishing a login identifier and present payment information using, for example, a credit card number. E-mail is automatically generated that notifies the owner of the referral community that a new subscriber has joined and that notifies the referral partners in the referral community to welcome the new partner. The new partner adds ideal client information as described above with respect to FIG. 17.

FIG. 18 is an illustrated flow diagram of an Invitation to Join a Referral Community web page. The person who receives a personal or corporate invitation (e.g., an invitation e-mail) to join a referral community enters the Invitation to Join Referral Community web page by selecting a link contained in the invitation e-mail. The web page will be presented a personalized web page with functionality and layout similar to the Public Homepage (see FIG. 9). The personalization of the web page may be based upon the invitation serial number that is generated at the time that the invitation is sent. Those skilled in the art recognize that web pages may be dynamically generated in response to user inputs as well as being generated before handing stored for nature access. The web page will solicit the professions and specialty of the invitee and a description of the invitees ideal sale and provide an opportunity to accept the invitation. If the invitee does not accept the invitation to join a referral community, the system 100 may optionally present additional terms including, for example, a guaranteed offer. If the entity still does not accept the presented invitation, the web page will log contact information of the reluctant invitee so that informational and promotional materials may be sent to the invitee. If the invitee accepts the invitation, the Referral Community Manager 105 (see FIG. 1) determines if the invitee is a current subscriber and if so, allows the invitee to logon, else allows the invitee to subscribe to the referral service (see FIG. 17).

After the invitee has been established as a new invitee or identified as a subscriber, the invitee is given the opportunity to join an existing referral community, establish a new referral community, or both establish and join a new referral community. If the subscribing invitee decides to join an existing referral community, an e-mail is automatically sent to the owner of the referral community that notifies the owner of the invitee's acceptance.

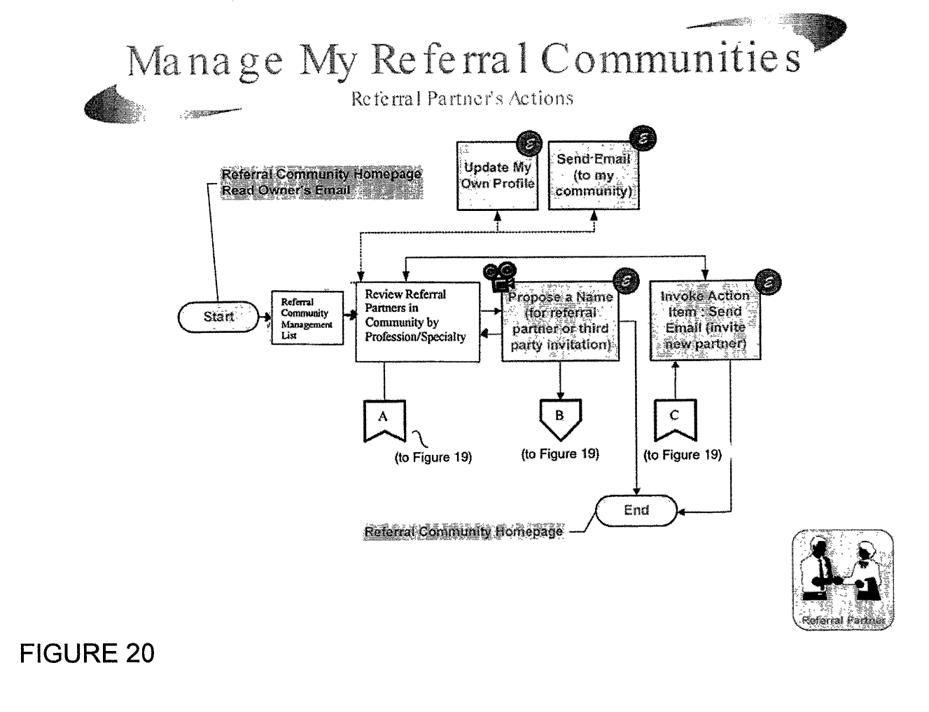

The invitee is provided an opportunity to enter an Ideal Client Profile (see FIG. 16). A comparison is performed with the Ideal Client Profiles of the invitee and the other referral partners in the referral community. The Manage Referral Community web page (which is described below with reference to FIG. 20) is presented to the invitee so that the invitee may propose a name or profession by which to fill the vacant desirable professions and specialties within the referral community. As discussed above, desirable professions and specialties are generally related to some aspect of business in the referral community and are generally complementary in nature rather than competitive. That is, it is generally not desirable to include multiple partners in a referral community that are in direct competition with each other. However, direct competition may be desirable in a referral community where the demand for a particular service exceeds the ability of the partners to meet that demand.

If the invitee chooses to both join and establish a new referral community, the owner of the referral community is notified by e-mail about the acceptance, an action item Set Up Community is inserted in the subscribing invitee's Action List, the invitee establishes an Ideal Client Profile and performs a Profile Comparison, and relevant information is presented by the Manage Referral Community web page (which is described below with reference to FIG. 20). If the subscribing invitee decides to only establish a new referral community, the invitee is presented with the Set Up a New Subscriber web page (see FIG. 17). Training and further promotional material are automatically sent to the subscribing invitee by the system 100.

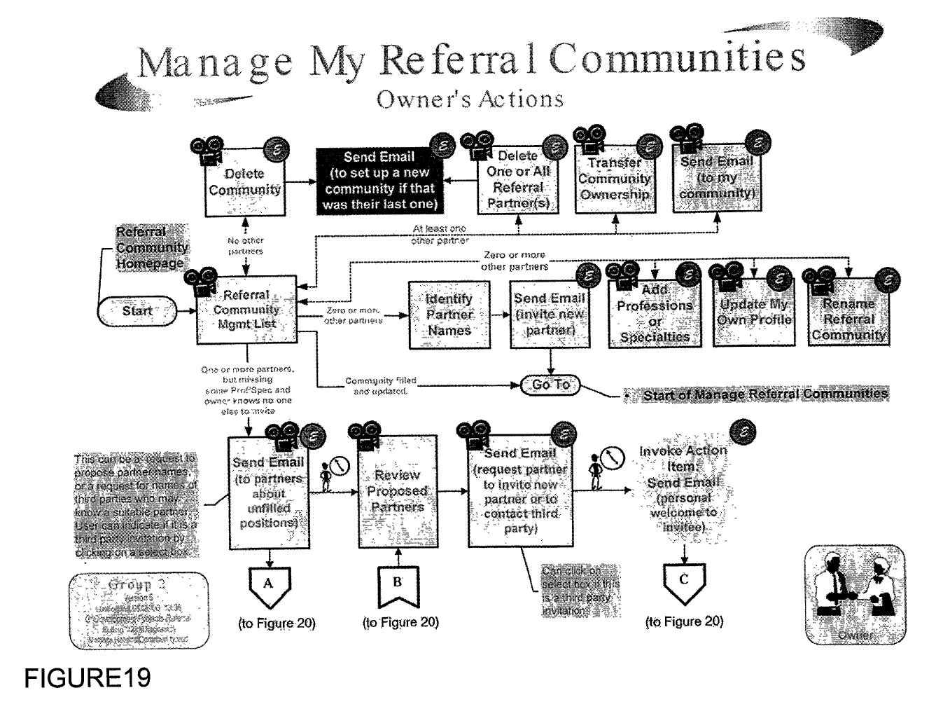

FIG. 19 is an illustrated flow diagram of an example Manage my Referral Communities (Owner's Actions). The owner of a referral community may access the Manage my Referral Communities (Owner's Actions) web page from the Referral Community Homepage (see FIG. 10). The Referral Community Management List is a menu of selections that allows the owner to select and execute processes and thereby manage the referral community. If there are no partners other than the owner in the referral community, the owner may delete the community from the system 100.

If there is at least one other partner in addition to the owner of the referral community, the owner may delete one or all of the partners, transfer community ownership of the referral community, or send e-mail to one or more of the partners in the owner's referral community. If a referral community has been deleted, the owner may send an e-mail message to an entity (i.e., a corporation or a person) asking to set up a new referral community if the entity is no longer represented in any existing referral community.

If there are any number of other partners in addition to the owner of the referral community, the owner may identify potential partner names and use the Referral Community Manager 105 (see FIG. 1) to generate and send an e-mail message to invite a potential partner to join the new referral community. In addition, the owner may add more professional or specialties categories to the Community Specialization and Professions list, update the owner's profile, or rename the referral community. The routine used to rename the referral community may also be accessed from other menus, such as the Identify Community Specialization/Professions, Identify Partner Names, and Sending E-mail: Invite New Partners routines previously described.

If there is at least one other partner in addition to the owner of the referral community, the owner may send an e-mail message to the other partners about unfilled positions in the Community Specialization and Professions list. The e-mail message can be a request for the other partners to identify candidate referral partners or it can be a request for the names of third parties who may know of suitable candidates interested in becoming a partner in the referral community. The owner of the referral community may indicate if the request is for a third party invitation by clicking on a select box in the E-mail template provided by the Referral Community Manager 105 (see FIG. 1). As described below with reference to FIG. 20, referral partners of the owner's referral community receive the owner's request for additional referral partners in response to the message identifying the proposed partners or third parties. One skilled in the art will appreciate that these communications may be accomplished through e-mail messages, e-mail messages containing interactive forms, e-mail messages containing hyperlinks to an interactive web page, postal letters, and the like. The owner of the referral community reviews the responses identifying the proposed partners or third parties. If the owner approves the response, the owner sends an e-mail request for the referral partner to invite the proposed partner or to contact the third party. The Referral Community Manager 105, upon approval of the proposed partner, will insert an action item into the Action list (see FIG. 11) of the partner that is responsible for sending the invitation. Thus, the system 100 provides a convenient mechanism for expanding a referral community to include partners that have complementary skills and referral capabilities. The system 100 further provides a convenient mechanism to remind individuals of tasks that need to be completed.

FIG. 20 is an illustrated flow diagram of an example Manage my Referral Communities is (Referral Partner's Actions). A referral partner of a referral community may access the Manage my Referral Communities (Referral Partner's Actions) web page from the Referral Community Homepage (see FIG. 10) or from the e-mail request from the owner of the referral community by, for example, selecting a hyperlink embedded in the e-mail request. The Referral Community Management List for the referral partner is a menu of selections that allows any partner in the referral community to take actions that manage the referral community. Upon receipt of a request from the referral community owner for a proposed partner or third party, the partner reviews the existing professional/specialties of the referral partners in the referral community according to the Community Professions Specialties list to determine which desired professions/specialties categories have not been filled. The partner responds to the owner's request by proposing a name of a potential partner or to a potential third party invitation. As described above with reference to FIG. 19, the Referral Community Manager 105 (see FIG. 1), upon approval of the proposed partner, will insert an action item into the Action List (see FIG. 11) of the partner that is responsible for sending the invitation. Any partner in the referral community may also update their own profile as well as send e-mail to other partners in the referral community using the menu items of FIG. 20.

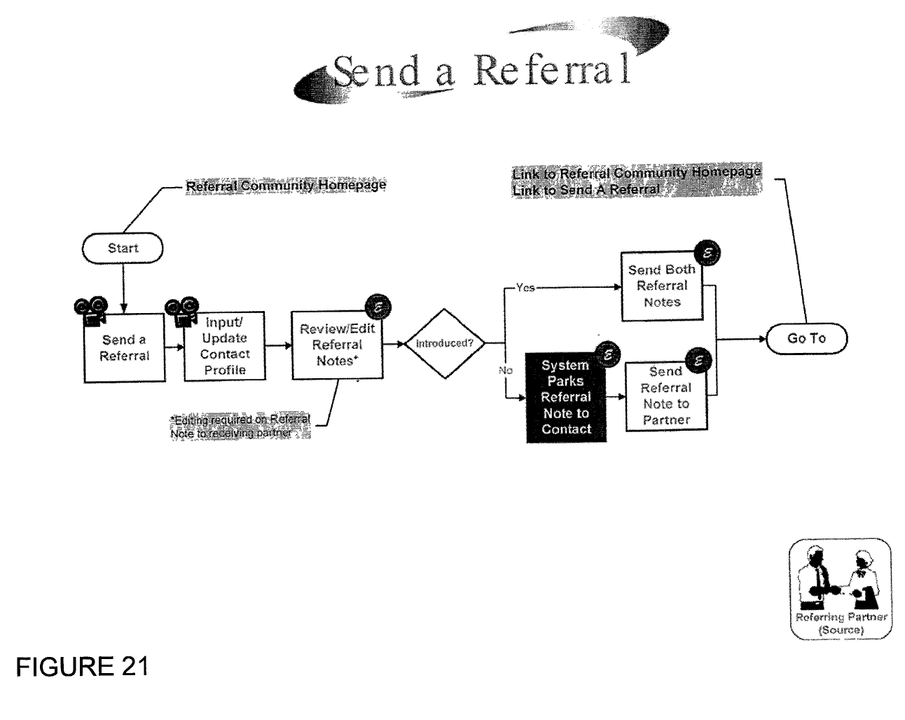

FIG. 21 is an illustrated flow diagram of an example Send a Referral web page to permit the referring partner to send a referral to the receiving partner in the referral community. The referring partner may access the Send a Referral web page from the Referral Community Homepage about a potential new client (i.e., “contact”) to the receiving partner. After selecting the Send a Referral menu item, the partner inputs or updates the contact profile for a potential referral. The Referral Community Manager 105 (see FIG. 1) uses the contact profile information to generate referral notes, which are presented to the referring partner for reviewing and editing. A referral note is customized for the receiving partner and another referral note is customized for the contact. If the Referral Community Manager 105 is informed that the contact has already been introduced to the receiving partner, the Referral Community Manager 105 sends the customized referral notes to the receiving partner and the contact. If the Referral Community Manager 105 has not been informed whether the contact has been introduced to the receiving partner or has been informed that no introduction has occurred, the Referral Community Manager 105 “parks” (i.e., temporarily stores) the customized referral meant for the contact and sends only the customized referral note to the receiving partner.

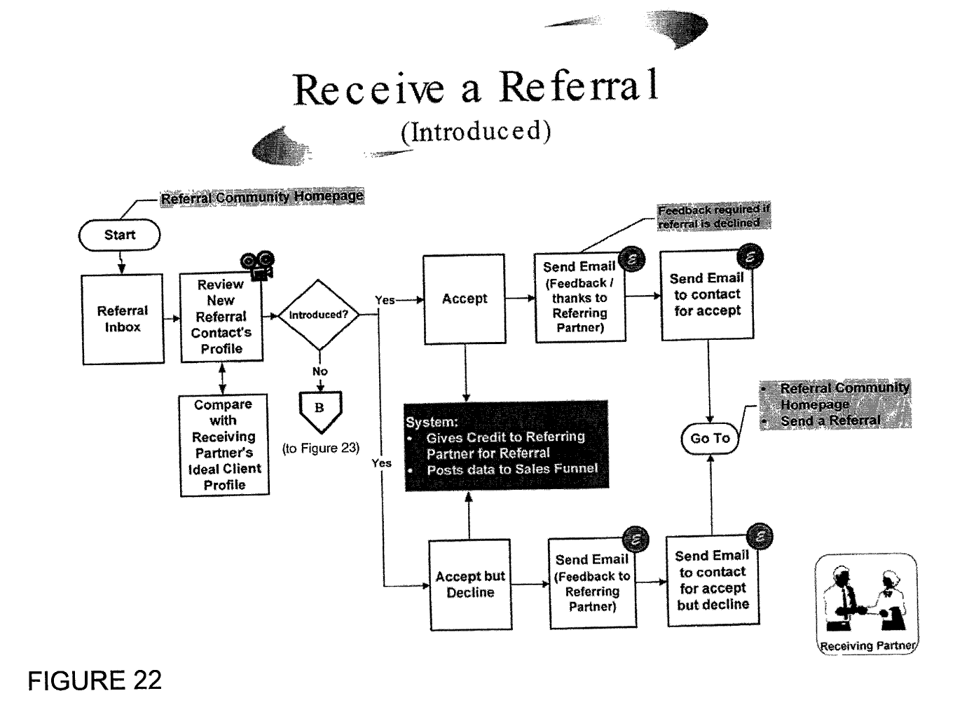

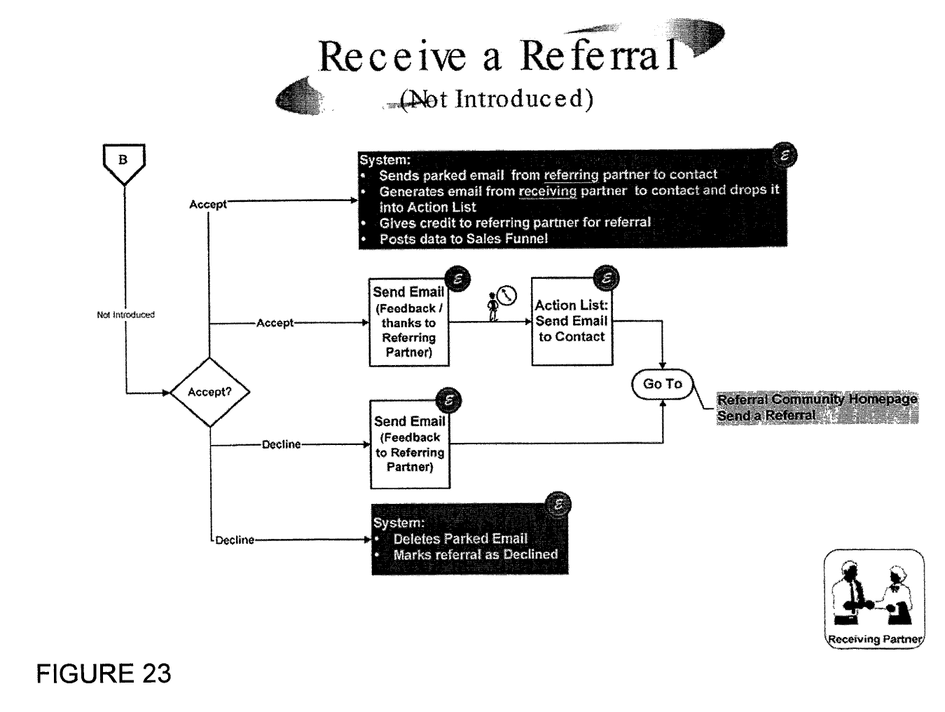

FIG. 22 is an illustrated flow diagram of a Receive a Referral (Introduced) web page. The receiving partner may enter the Receive a Referral (Introduced) web page from the Referral Community Homepage (see FIG. 10). The receiving partner receives the referral in the Referral Inbox (e.g., an e-mail inbox for the referral community) and reviews the New Referral Contact's Profile, comparing it with the receiving partners own Ideal Client Profile. If the receiving partner has not been introduced to the contact, the receiving partner will accept or decline the referral as described below with reference to FIG. 23. If the receiving partner has been introduced and accepts the referral, the Referral Community Manager 105 (see FIG. 1) credits the referring partner for the referral and posts related data to the Sales Funnel. The Referral Community Manager 105 also generates e-mail templates for the receiving partner to give feedback and send thanks to the referring partner and for the receiving partner to send to the contact a notification of the acceptance. If the introduced receiving partner initially accepts the referral, but later decides to decline the referral, the Referral Community Manager 105 credits the referring partner for the referral and posts the related data to the Sales Funnel. The Referral Community Manager 105 also generate e-mail templates for the receiving partner to give feedback information to the referring partner and for the receiving partner to send the contact notification that the receiving partner has accepted but declined the referral.

FIG. 23 is an illustrated flow diagram of the Receive a Referral (Not introduced) web page. The unintroduced receiving partner may enter the Receive a Referral (Not Introduced) web page after receiving a new referral in which the receiving partner has not been introduced to the contact (see FIG. 22). If the unintroduced receiving partner accepts the referral, the Referral Community Manager 105 (see FIG. 1) sends the parked e-mail (which was described above with reference to FIG. 22) from the referring partner to the contact, generates e-mail templates for the receiving partner to send to the contact and enters the item into the receiving partner's Action List (see FIG. 11), credits the referring partner for the referral, and posts the related data to the Sales Funnel. The Referral Community Manager 105 also generates e-mail templates for the unintroduced receiving partner to use to the give feedback and send thanks to the referring partner. The receiving partner encounters the e-mail for the contact in the receiving partner's Action List and sends the contact the e-mail message notifying the contact of the receiving partner's acceptance of the referral. If the unintroduced receiving partner declines the referral, the Referral Community Manager 105 deletes the parked e-mail, marks the referral as declined, and generates e-mail templates for the unintroduced receiving partner to send to the referring partner. The unintroduced receiving partner modifies the e-mail templates to provide feedback and send e-mail to the referring partner. The system 100 provides a significant improvement over the conventional “cold call” customer contact system by providing introductions from the referring partner to the contact so that the receiving partner benefits from the introduction and improves the likelihood of success.

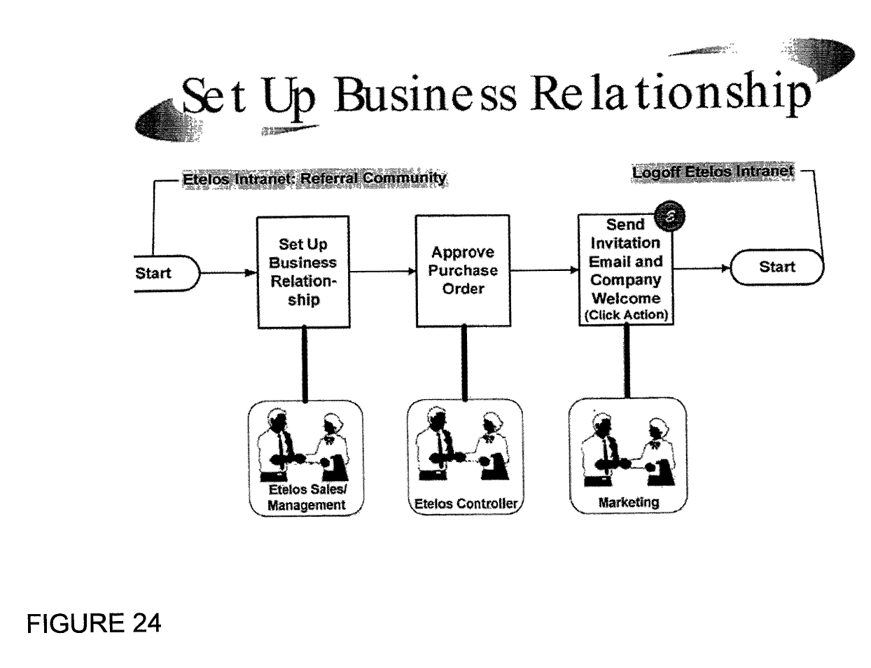

FIG. 24 is an illustrated flow diagram of a Set Up a Business Relationship web page. The Set Up a Business Relationship is used by the provider of the system 100 to establish referral community for entities, such as corporations. The system 100 tracks the contacts by sales personnel, awaits approval for purchase orders, and sends invitation e-mail messages containing links to web pages that are specific to the company-related purchase order.

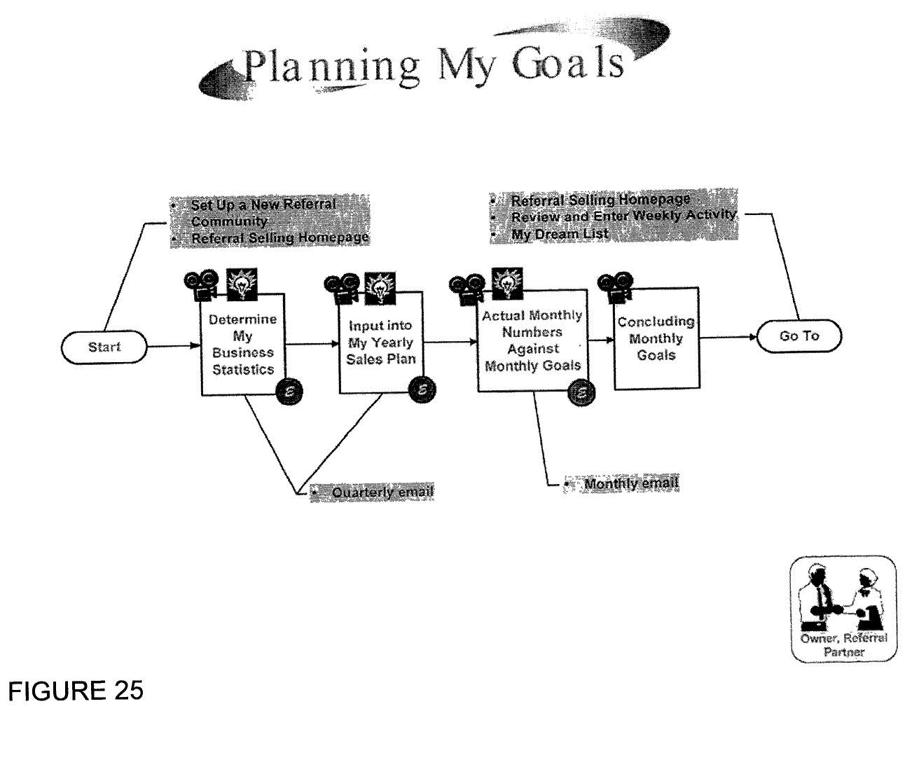

FIG. 25 is an illustrated flow diagram of a Planning my Goals web page. Owners and referral partners may enter the Planning my Goals web page from the Set Up a New Referral Community web page (see FIG. 15). The Referral Community Manager 105 (see FIG. 1), on a quarterly basis, determines business statistics of an owner or a referral partner and enters the information into the owner or referral partner's yearly sales plan. The Referral Community Manager 105 also computes on a monthly basis actual sales figures related to referrals and compares them with the monthly goals of the owner or referral partner. The Referral Community Manager 105 sends e-mail to the owner or referral partner with the results and conclusions of the computed calculations.

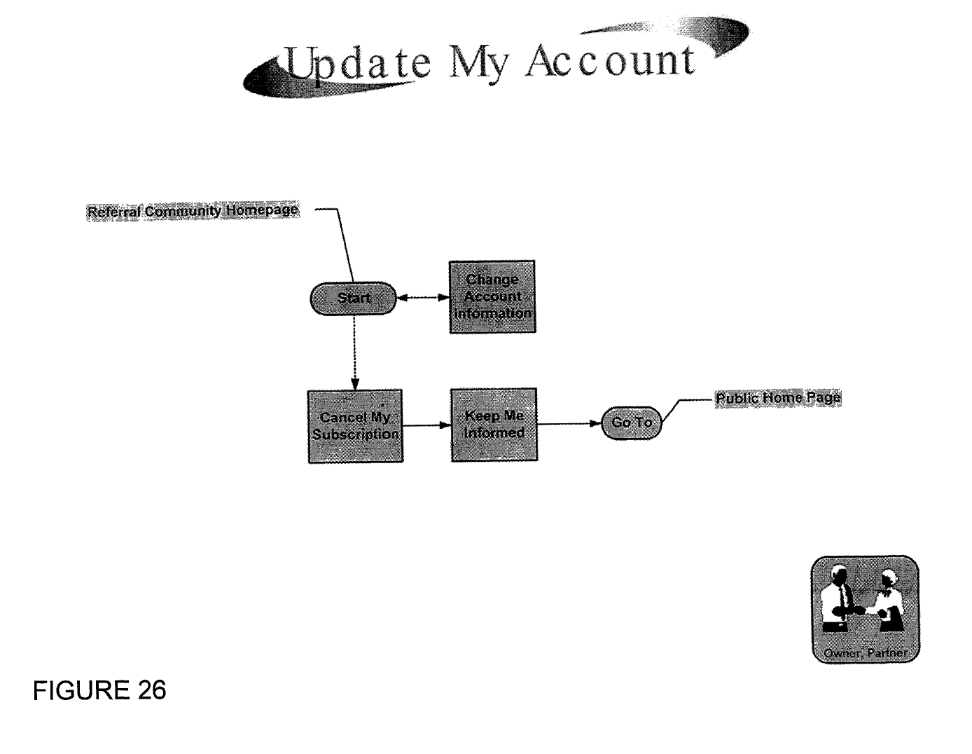

FIG. 26 is an illustrated flow diagram of an Update my Accounts web page. An owner or a partner may access the Update my Accounts web page from the Referral Community Homepage (see FIG. 10) to change account information or to cancel their subscriptions. If the owner or a partner decides to cancel their subscription, the Referral Community Manager 105 (see FIG. 1) may optionally provide motivational and informational statements to the canceling owner or partner on a regular basis.

From the foregoing it will be appreciated that, although specific embodiments of the invention have been described herein for purposes of illustration, various modifications may be made without deviating from the spirit and scope of the invention. For example, one skilled in the art will recognize that the methods and systems discussed herein are applicable to various implementations for managing business referrals across any network, or even a plurality of such networks. One skilled in the art will also recognize that the methods and systems discussed herein are applicable to differing protocols, communication media (optical, wireless, cable, and the like) and client devices (such as wireless handsets, electronic organizers, personal digital assistants, portable e-mail machines, pagers, and the like).

What is claimed is: METHOD OF MANAGING BUSINESS REFERRALS (SYSTEMS VIEW)

1. A method in a computer system and network for managing business referrals, the method comprising:
establishing a referral list comprising data related to a plurality of entities that desire referrals to identify potentially desirable clients;
storing a general characterization of potentially desirable clients for a selected one of the plurality of entities,
sending to others of the pluralities of entities a request representing the general characterization; and
receiving a response to the request from at least one of the others of the plurality of entities, the response identifying a potentially desirable client to the selected entity.
Contact information from referral list

2. The method of claim 1 wherein contact information from the referral list is used to send the requests.
Sending a message to the potential client

3. The method of claim 1, further comprising sending a communication to the identified potentially desirable client to thereby refer the identified potentially desirable client to the selected entity.
Automatically sending a message to the potential client

4. The method of claim 3 wherein the sending of the communication is accomplished automatically without intervention by the selected entity or the at least one of the others of the plurality of entities.
Automatically sending an e-mail message to the potential client

5. The method of claim 4 wherein the communication that is sent is e-mail.
The potential client answers the referral

6. The method of claim 3, further comprising the identified potentially desirable client responding to the referral communication.
The potential client accepts the referral

7. The method of claim 6 wherein the response comprises an acceptance of the referral communication.
The potential client declines the referral

8. The method of claim 6 wherein the response declines the referral communication.
The potential client is automatically reminded to answer the referral

9. The method of claim 6, further comprising reminding the identified potentially desirable client to respond to the referral communication if the identified potentially desirable client has not responded to the referral within a predetermined time period.
Adding to the entities

10. The method of claim 1, further comprising adding an entity to the plurality of entities.
Creating an ideal client profile for the added entity

11. The method of claim 10, further comprising storing a general characterization of potentially desirable clients for the added entity.
Generating sales data from referrals

12. The method of claim 1, further comprising storing, processing, and reporting data related to sales resulting from referrals of potentially desirable clients.
Generating sales data for each referral

13. The method of claim 12 wherein the storing, processing, and reporting of sales data is performed for each of the referrals of potentially desirable clients.
Tracking referral

14. The method of claim 1, further comprising storing, processing, and reporting the referrals of potentially desirable clients.
Tracking referrals given by each entity

15. The method of claim 14 wherein the storing, processing, and reporting the referrals of potentially desirable clients is performed according to each of the plurality of entities.
Tracking referrals given by each entity for a predetermined time

16. The method of claim 15 wherein the storing, processing, and reporting the referrals of potentially desirable clients is performed according to each of the plurality of entities for a predetermined period of time.
METHOD OF MANAGING BUSINESS REFERRALS (ENTITY VIEW)

17. A method in a computer sys tem and network for managing business referrals between business entities, the method comprising:
submitting a general description of potentially desirable clients to a referral list by a selected entity;
receiving a response from at least one of the other entities, the response identifying a potentially desirable client to the selected entity; and
receiving an inquiry from the identified potentially desirable client, wherein the identified potentially desirable client has been sent a communication indicating the referral.
Entity receives information relating to the value of the referrals

18. The method of claim 17, further comprising receiving data relating to the sales resulting from the referral received from at least one of the other entities.
Entity selects a general description of potentially desirable clients

19. The method of claim 17, wherein the selected entity submits a general description of potentially desirable clients by selecting from a menu offering types of clients.
METHOD OF MANAGING BUSINESS REFERRALS (CLIENT/CONTACT VIEW)

20. A method in a computer system and network for managing business referrals, the method comprising:
receiving a referral from a first entity that identifies a second entity as a possible entity with which to do business, wherein the second entity has submitted a general description of potentially desirable clients to a referral list;
responding to the referral by sending a communication to the first entity; and
contacting the second entity identified by the referral.
Notification of referral to a referral list manager

21. The method of claim 20 further comprising sending a communication to a referral list manager.
Communication generated in part by system

22. The method of claim 20, wherein the communication responding to the referral is generated in part by activation of a link contained in the referral from a first entity.
METHOD OF MANAGING BUSINESS REFERRALS (REFERRING ENTITY VIEW)

23. A method in a computer system and network for managing business referrals, the method comprising:
receiving a representation of a general description of potentially desirable clients described by a selected entity, wherein the selected entity has previously submitted the general description of potentially desirable clients;
sending a referral to identify a potentially desirable client to the selected entity; and
receiving a response to the referral from the selected entity, wherein the response indicates a status of the referral.
The potential client accepts the referral

24. The method of claim 23 wherein the status is referral accepted.
The potential client declines the referral

25. The method of claim 23 wherein the status is referral declined.
METHOD OF MANAGING BUSINESS REFERRALS (BEAUREGARD)

26. A computer disk containing executable code for managing business referrals, the code comprising executable instructions for:
establishing a referral list comprising data related to entities that desire to identify potentially desirable clients;
storing a general description of potentially desirable clients for a selected entity,
sending to others of the entities a request representing the general description; and
receiving a response to the request from at least one of the other entities, the response identifying a potentially desirable client to the selected entity.
Contact information from referral list

27. The method of claim 26 wherein contact information from the referral list is used to send the requests.
Sending a message to the potential client

28. The method of claim 26, further comprising sending a communication to the identified potentially desirable client to thereby refer the identified potentially desirable client to the selected entity.
The potential client answers the referral

29. The method of claim 28, further comprising the identified potentially desirable client responding to the referral communication.
DATA STRUCTURE CLAIM

30. A data structure in a computer storage mechanism for managing business referrals, the structure comprising:
a field for storing a requesting entity name;
one or more fields for storing descriptions of potentially desirable clients for the requesting entity; and
a field for storing a responding entity name.
SYSTEM FOR MANAGING BUSINESS REFERRALS (MEANS PLUS FUNCTION CLAIM)

31. A computer system and network for managing business referrals, the system comprising:
means for establishing a referral list comprising data related to entities that desire to identify potentially desirable clients;
means for storing a general description of potentially desirable clients for a selected entity,
means for sending to others of the entities a request representing the general description; and
means for receiving a response to the request from at least one of the other entities, the response identifying a potentially desirable client to the selected entity.
SYSTEM FOR MANAGING BUSINESS REFERRALS (APPARATUS CLAIM)

32. A computer system and network for managing business referrals, the system comprising:
a referral list comprising data related to entities that desire to identify potentially desirable clients;
a referral partner database manager, wherein the referral partner database manager manages the referral list, receives communications from the entities and the identified potentially desirable clients, and sends communications to the entities and the identified potentially desirable clients; and
a communication medium that links the referral partner database manager to the entities and the identified potentially desirable clients.

33. A method of using referral surveys, comprising:
sending to a customer a referral query;
receiving from the customer a message in an electronic medium containing a referral;
extracting the referral from the message; and
sending the referral to a subscriber.

34. The method of 33, further comprising:
sending a referral survey to the customer whereby the sending to a customer a referral query is initiated in response to receiving a completed referral survey from the customer.

35. The method of 34, further comprising:
sending to the customer an email containing a link to a referral survey.

36. The method of 35, further comprising:
creating a referral survey in response to the customer activating the link.

37. The method of 33, further comprising:
sending an introduction to an entity named by the referral.

38. The method of 37, further comprising:
obtaining the subscribers permission to send an introduction to an entity named by the referral.
